(19) United States
(12) Patent Application Publication
(10) Pub. No.: US 2014/0020571 A1
(43) Pub. Date: Jan. 23, 2014

(54) Rotary Machine for Separation of a Hard Plant Component from a Connected Soft Matter Component

(71) Applicants: Rick Wendell Bajema, Plano, TX (US); Christopher E. Graham, Sandy Hook, CT (US); Joseph Halligan, Sacramento, CA (US); James L. Pfister, Mechanicsburg, PA (US); Joseph Furmansky, Canandaigua, PA (US); Steven A. Von Rhedey, Dresden, NY (US); Steven P. Von Rhedey, Hammondsport, NY (US)

(72) Inventors: Rick Wendell Bajema, Plano, TX (US); Christopher E. Graham, Sandy Hook, CT (US); Joseph Halligan, Sacramento, CA (US); James L. Pfister, Mechanicsburg, PA (US); Joseph Furmansky, Canandaigua, PA (US); Steven A. Von Rhedey, Dresden, NY (US); Steven P. Von Rhedey, Hammondsport, NY (US)

(73) Assignee: The Concentrate Manufacturing Company of Ireland, Hamilton (BM)

(21) Appl. No.: 13/552,353

(22) Filed: Jul. 18, 2012

(51) Int. Cl. A23N 5/00

(52) U.S. Cl. CPC A23N 5/00
USPC 99/569

(57) ABSTRACT

Aspects of the present invention relate to a system configured for separating a nut or other hard component from soft matter connected to the hard component. The system includes first and second rotary modules. The first rotary module includes a cylindrical first chamber defined by an inner surface and a first rotary assembly within the first chamber. The second rotary module is in communication with the first rotary module such that the first rotary module feeds the hard component and the pulp into the second rotary module. The second rotary module includes a cylindrical screen defining a cylindrical second chamber and a second rotary assembly disposed within the second chamber. The system may further include an infeed assembly for feeding the material into the first rotary module, and/or a discharge portion for discharging the hard component through an exit port after separation by the second rotary module.

### TECHNICAL FIELD

The invention relates generally to a machine for the separation of nuts or other hard plant components from fruits or other soft matter components, and in a more specific embodiment, for separating a cashew nut from a cashew apple connected to the nut.

### BACKGROUND

The cashew-nut tree is an evergreen tropical tree with the fruit ripening within 2 months. The fruit of the cashew tree, called the cashew fruit or cashew apple, is an accessory fruit (sometimes called a pseudocarp or false fruit) that is an oval or pear-shaped structure that develops from a pedicel and the receptacle of the cashew flower. The cashew apple ripens into a yellow and/or red structure about 5-11 cm long. The cashew apple is edible, and has a strong “sweet” smell and a sweet taste.

The true fruit of the cashew tree is a kidney-shaped drupe that grows at the end of the cashew apple. The cashew fruit develops first on the tree, and then the pedicel expands to become the cashew fruit. Adjacent and connected to the cashew fruit is a single seed, the cashew nut. The seed is surrounded by a double shell. It is desirable to avoid breaking or rupturing the shell during processing, for a variety of reasons.

Currently cashew nuts are separated from the cashew fruit by hand. This process is very time consuming and labor intensive. Nut and cashew fruit harvesting, for example, seeks technologies that improve costs, improve the yield and reduce the time from cashew fruit harvesting to processing. Accordingly, technologies that can achieve reduced costs through less labor, maximizing the yield, and/or reducing the time from harvesting to processing can be extremely beneficial to the nut and cashew nut industry, as well as other areas of the nut industry and other types of plant growing industries. Some of these advantages and benefits may be achieved by the use of a mechanical nut separator that has specific structural features or other features that can reduce costs, improve yield, and reduce the time from harvesting to fruit processing.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

Aspects of the present invention relate to a system configured for processing plant tissue to separate a nut or other hard component from soft matter connected to the hard component. The system includes a first rotary module and a second rotary module. The first rotary module includes a static profile structure and a rotating profile structure. The static profile structure enables softening of the fruit and works in combination with the rotating profile structure. The rotating profile structure promotes rotation and impacts with the static profile structure. Together these two structures simultaneously promote softening of the fruit and cutting of the soft fruit fiber away from the hard component without damage to the hard component. Furthermore, the first rotary module includes a cylindrical first chamber defined by an inner surface and a first rotary assembly disposed within the first chamber. The inner surface may have a plurality of projections and a plurality of troughs interspersed between the projections. The first rotary assembly includes a first shaft that is powered for rotation within the first chamber and a plurality of first vanes extending radially from the first shaft and extending longitudinally along at least a portion of a length of the first shaft. Each of the first vanes may have a free edge adjacent the inner surface and each of the vanes have a knife connected to the free edge. The first rotary module may be configured for crushing the soft matter by contact of the soft matter with the first vanes and the inner surface during rotation of the first rotary assembly to form a pulp. The knives may be configured for cutting the hard component from a fibrous component of the pulp. The second rotary module may be in communication with the first chamber of the first rotary module such that the first rotary module is configured to feed the hard component and the pulp into the second rotary module. The second rotary module includes a cylindrical screen defining a cylindrical second chamber and a second rotary assembly disposed within the second chamber. The screen may have a plurality of passages and shapes to enable cutting and removal of fibers and plant tissue without damage to the hard component. The second rotary assembly may include a second shaft that is powered for rotation within the second chamber and a plurality of paddles extending radially from the second shaft and extending longitudinally along at least a portion of a length of the second shaft. The second rotary module is configured for separating the hard component from the pulp by the rotation of the second rotary assembly, such that the passages are configured to permit the pulp to pass through and prevent passage of the hard component.

According to one aspect, the system further includes an infeed assembly configured for feeding the hard component and the connected soft matter into the first rotary module.

According to another aspect, the system further includes a discharge portion in communication with the second chamber of the second rotary module, wherein the discharge portion is configured to discharge the hard component through an exit port after separation by the second rotary module.

According to another aspect, each of the first vanes may have a rear end proximate an output of the first rotary module and a fin projecting from the rear end, wherein each of the fins has a leading edge projecting longitudinally and radially outward from the free edge of the first vane to which the respective fin is connected. In one embodiment, each of the knives may be removably connected to a side of the respective first vane and extends parallel and adjacent to the free edge of the first vane. In one embodiment, each of the fins has a second knife located thereon with the second knife located on the leading edge of the respective fin. In another embodiment, each of the second knives may be integrally formed on the leading edge of the fin. In another embodiment, each of the second knives may be removably connected to a side of the respective fin and extends parallel and adjacent to the leading edge.

According to another aspect, a maximum clearance between the free edges of the first vanes and the inner surface of the first chamber may be no greater than 50% of the smallest diameter of the hard component being processed.

According to another aspect, each of the first vanes has a leading edge distal from the second rotary module, wherein each leading edge is beveled to form an angle of greater than 90° between the free edge and the leading edge to simultaneously promote stretching and orientation of the fruit fibers away from the hard component within the troughs of the static profile structure and then cutting of the fibers when the knife on the leading edge encounters the tight clearances between the knife edge and the projections of the static profile.

According to yet another aspect, the first rotary assembly may have a leading face with a conical surface. The conical surface may be angled at approximately 15° to 75° with respect to a rotational axis of the first rotary assembly as defined by the first shaft.

Additional aspects of the invention relate to a system configured for separating a hard component from soft matter connected to the hard component with the system comprising a first rotary module and a second rotary module. The first rotary module includes a cylindrical first chamber defined by an inner surface and a first rotary assembly disposed within the first chamber. The inner surface may have a plurality of projections and a plurality of troughs interspersed between the projections. The first rotary assembly may include a first shaft that is powered for rotation within the first chamber and a plurality of first vanes extending radially from the first shaft and extending longitudinally along at least a portion of a length of the first shaft. Each of the first vanes may have a free edge adjacent the inner surface. The first rotary module may be configured for crushing the soft matter by contact of the soft matter with the first vanes and the inner surface during rotation of the first rotary assembly to form a pulp. The second rotary module includes a cylindrical screen defining a cylindrical second chamber and a second rotary assembly disposed within the second chamber. The second chamber may have an entry end in communication with the first chamber of the first rotary module, such that the first rotary module is configured to guide and feed the hard component and the pulp into the entry end of the second chamber, and an exit end opposite the entry end. The screen may have a plurality of passages to simultaneously promote cutting and removal of fiber without damage to the hard component. The second rotary assembly includes a second shaft that is powered for rotation within the second chamber and a plurality of paddles extending radially from the second shaft and extending longitudinally along at least a portion of a length of the second shaft. The second rotary module may be configured for separating the hard component from the pulp by rotation of the second rotary assembly such that the passages are configured to permit the pulp to pass through and prevent passage of the hard component. Each of the paddles has a leading edge proximate the entry end that is spaced 1/16″ or less from the rear ends of the paddles exiting from the first rotary module. The closer the spacing and more continuous the transition, the reduced probability of fibers accumulating and reducing throughput through the first rotary module.

According to one aspect, each of the paddles may have a base attached to the second shaft and a free edge adjacent the screen. According to another aspect, the system may also include an infeed assembly that is configured for feeding the hard component and the connected soft matter into the first rotary module.

According to a further aspect, the system may also include a discharge portion in communication with the second chamber of the second rotary module, wherein the discharge portion is configured to discharge the hard component through an exit port after separation by the second rotary module.

According to yet another aspect, the passages of the screen have a maximum dimension that is no greater than 25% or no greater than 50% of the smallest diameter of the hard component being processed to prevent cutting and damage to the hard component.

According to another aspect, the first chamber and the second chamber are continuous with each other and form a single, continuous chamber.

According to a still further aspect, the first rotary assembly and the second rotary assembly rotate at approximately equal speeds. For example, the first rotary assembly and the second rotary assembly may rotate at approximately 200-1600 RPM, or approximately 600-1200 RPM, or approximately 900 RPM. As another example, the first rotary assembly and the second rotary assembly may rotate at approximately 200-1600 RPM, or approximately 200-800 RPM, or approximately 600 RPM. In one embodiment, the first shaft and the second shaft may be operably locked, such that the first and second shafts rotate together.

Further aspects of the invention include dividing up the functions of the in-feed section, the first rotary module, and the second rotary module into separate chambers that feed each other but are not directly mechanically linked. An example includes a positive displacement pump that pumps the fruit while softening it to feed the first rotary module. The nuts and crushed fruit from the first rotary module then flow to a separate rotor system which separates the nuts from the crushed fruit and further cuts and softens the crushed fruit for good recovery of juice.

Further aspects of the invention relate to a system configured for separating a hard component from soft matter connected to the hard component that includes a first rotary module, a second rotary module, and a discharge portion. The first rotary module includes a cylindrical first chamber defined by an inner surface and a first rotary assembly disposed within the first chamber. The inner surface may have a plurality of projections and a plurality of troughs interspersed between the projections. The first rotary assembly may include a first shaft that is powered for rotation within the first chamber and a plurality of first vanes extending radially from the first shaft and extending longitudinally along at least a portion of a length of the first shaft. Each of the first vanes may have a free edge adjacent the inner surface. The first rotary module may be configured for crushing the soft matter by contact of the soft matter with the first vanes and the inner surface during rotation of the first rotary assembly to form a pulp. The second rotary module includes a cylindrical screen defining a cylindrical second chamber and a second rotary assembly disposed within the second chamber. The second chamber may have an entry end in communication with the first chamber of the first rotary module such that the first rotary module is configured to feed the hard component and the pulp into the entry end of the second chamber. The second chamber may also have an exit end opposite the entry end. The screen may have a plurality of passages that allow passage for pulp (e.g. crushed fruit puree) without damage to the hard component. The second rotary assembly may include a second shaft that is powered for rotation within the second chamber and a plurality of paddles extending radially from the second shaft and extending longitudinally along at least a portion of a length of the second shaft. The second rotary module may be configured for separating the hard component from the pulp by rotation of the second rotary assembly, such that the passages are configured to permit the pulp to pass through and prevent passage of the hard component. The discharge portion may be in communication with the exit end of the second chamber of the second rotary module. The discharge portion may be configured to discharge the hard component through an exit port after separation by the second rotary module. The exit port may be positioned adjacent to the exit end of the second chamber. Furthermore, each of the paddles may have a rear end at the exit end of the second chamber, wherein the rear ends of the paddles do not overlap the exit port.

According to another aspect, the discharge portion may include an extension of the second chamber with the extension defined by a cylindrical wall. The exit port may include a circumferential opening in the cylindrical wall.

According to yet another aspect, the system further includes an infeed assembly that is configured for feeding the hard component and the connected soft matter into the first rotary module.

Still further aspects of the invention relate to a system configured for separating a hard component from soft matter connected to the hard component that includes a first rotary module, a second rotary module, and a discharge portion. The first rotary module includes a cylindrical first chamber defined by an inner surface and a first rotary assembly disposed within the first chamber. The inner surface may have a plurality of projections and a plurality of troughs interspersed between the projections. The first rotary assembly may include a first shaft that is powered for rotation within the first chamber and a plurality of first vanes extending radially from the first shaft and extending longitudinally along at least a portion of a length of the first shaft. Each of the first vanes may have a free edge adjacent the inner surface. The free edge may also contain knives of various types to cut the fibers away from the hard component without damaging the hard component. The first rotary module is configured for crushing the soft matter by contact of the soft matter with the first vanes and the inner surface during rotation of the first rotary assembly to form a pulp. The knives attached the first vanes serve to cut the fibers away from the hard component without damage to the hard component. The second rotary module includes a cylindrical screen defining a cylindrical second chamber and a second rotary assembly disposed within the second chamber. The second chamber may have an entry end and an exit end opposite the entry end. The entry end may be in communication with the first chamber of the first rotary module, such that the first rotary module is configured to feed the hard component and the pulp into the entry end of the second chamber. The screen may have a plurality of passages. The second rotary assembly may include a second shaft that is powered for rotation within the second chamber and a plurality of paddles extending radially from the second shaft and extending longitudinally along at least a portion of a length of the second shaft. The second rotary module may be configured for separating the hard component from the pulp by rotation of the second rotary assembly, such that the passages are configured to permit the pulp to pass through and prevent damage to and passage of the hard component. The discharge portion may be in communication with the exit end of the second chamber of the second rotary module. The discharge portion may be configured to discharge the hard component through an exit port after separation by the second rotary module. The exit port may be positioned adjacent to the exit end of the second chamber. The discharge portion may further include a barrier plate extending into the exit port along an edge of the exit port adjacent the second chamber to form a barrier between the edge of the exit port and the exit end of the second chamber.

According to one aspect, each of the paddles may have a rear end at the exit end of the chamber. The rear ends of the paddles may overlap the exit port. Each of the rear ends may have a slit therein configured to provide clearance for the barrier plate to pass through the slit during rotation of the second rotary assembly.

According to another aspect, the barrier plate may be connected to the discharge portion outside the exit port and extends into the exit port from outside the exit port.

Still further aspects of the invention relate to a system configured for separating a hard component from soft matter connected to the hard component that includes an infeed assembly, a first rotary module, a second rotary module, and a discharge portion. The infeed assembly includes an auger configured for moving the hard component with the connected soft matter, without damaging the hard component. The first rotary module includes a cylindrical first chamber defined by an inner surface and a first rotary assembly disposed within the first chamber. The first chamber may have an entry end adjacent an end of the auger and an exit end opposite the entry end. The auger may be configured for feeding the hard component and the connected soft matter into the entry end. The inner surface may have a plurality of projections and a plurality of troughs interspersed between the projections. The first rotary assembly may include a first shaft that is powered for rotation within the first chamber and a plurality of first vanes extending radially from the first shaft and extending longitudinally along at least a portion of a length of the first shaft. Each of the first vanes may have a free edge adjacent the inner surface. Each of the vanes may have a knife connected to the free edge. The first rotary module may be configured for crushing the soft matter by contact of the soft matter with the first vanes and the inner surface during rotation of the first rotary assembly to form a pulp. The knives may be configured for cutting the hard component from a fibrous component of the pulp. The second rotary module includes a cylindrical screen defining a cylindrical second chamber and a second rotary assembly disposed within the second chamber. The second chamber may have an entry end in communication with the exit end of the first chamber of the first rotary module. The first rotary module may be configured to feed the hard component and the pulp from the exit end of the first chamber into the entry end of the second chamber. The second chamber may further have an exit end opposite the entry end. The screen may have a plurality of passages. The second rotary assembly may include a second shaft that is powered for rotation within the second chamber and a plurality of paddles extending radially from the second shaft and extending longitudinally along at least a portion of a length of the second shaft. The second rotary module may be configured for separating the hard component from the pulp by rotation of the second rotary assembly such that the passages are configured to permit the pulp to pass through and prevent damage to and passage of the hard component. The discharge portion may be in communication with the exit end of the second chamber of the second rotary module. The discharge portion may be configured to discharge the hard component through an exit port after separation by the second rotary module. The exit port may be positioned adjacent to the exit end of the second chamber. The discharge portion may include an extension of the second chamber, the extension defined by a cylindrical wall. The exit port may include a circumferential opening in the cylindrical wall.

According to one aspect, the discharge portion may further include a barrier plate extending into the exit port along an edge of the exit port adjacent the second chamber to form a barrier between the edge of the exit port and the exit end of the second chamber. Each of the paddles may have a rear end at the exit end of the chamber. The rear ends of the paddles may overlap the exit port. Each of the rear ends may have a slit therein configured to provide clearance for the barrier plate to pass through the slit during rotation of the second rotary assembly.

According to another aspect, each of the paddles may have a rear end at the exit end of the second chamber. The rear ends of the paddles may not overlap the exit port.

Other features and advantages of the invention will be apparent from the following specification taken in conjunction with the following drawings.

### DESCRIPTION OF THE DRAWINGS

To allow for a more full understanding of the present invention, it will now be described by way of example, with reference to the accompanying drawings in which.

FIG. 1A is a side perspective view of an embodiment of a mechanical nut separator according to aspects of the present invention;

FIG. 1B is a side perspective view of the mechanical nut separator illustrated in FIG. 1A according to aspects of the present invention;

FIG. 2 is a cut-away side view of the embodiment of the mechanical nut separator illustrated in FIG. 1A according to aspects of the present invention;

FIG. 3 is a top perspective view of the infeed portion of the mechanical nut separator illustrated in FIG. 1A according to aspects of the present invention;

FIG. 4A is a side perspective view of the first rotary module chamber according to aspects of the present invention;

FIG. 4B is a side perspective view of a rotor on the first rotary module according to aspects of the present invention;

FIG. 4C is a close-up, side perspective view of the rotor of the first rotary module according to aspects of the present invention;

FIGS. 4D1 and 4D2 are views of an embodiment of the rotor of the first rotary module according to aspects of the present invention;

FIGS. 4E1 and 4E2 are views of another embodiment of the rotor of the first rotary module according to aspects of the present invention;

FIG. 5 is a front perspective view of an embodiment of a first rotary module and a second rotary module as part of the mechanical nut separator illustrated in FIG. 1A according to aspects of the present invention

FIG. 6A is a front perspective view of the second rotary module according to aspects of the present invention;

FIG. 6B is a front view of the rotor of the second rotary module according to aspects of the present invention;

FIG. 7A is a front perspective view of a discharge portion of the mechanical nut separator according to aspects of the present invention;

FIG. 7B is a front perspective view of another embodiment of a discharge portion of the mechanical nut separator according to aspects of the present invention;

FIG. 8A is a view of an embodiment of a knife according to aspects of the present invention;

FIG. 8B is a view of an embodiment of another knife according to aspects of the present invention;

FIG. 8C is a view of an embodiment of another knife according to aspects of the present invention;

FIG. 9A is a schematic cross-sectional view of one embodiment of a static profile structure according to aspects of the present invention;

FIG. 9B is a schematic cross-sectional view of another embodiment of a static profile structure according to aspects of the present invention;

FIG. 9C is a schematic cross-sectional view of another embodiment of a static profile structure according to aspects of the present invention; and

FIG. 9D is a schematic cross-sectional view of another embodiment of a static profile structure according to aspects of the present invention.

### DETAILED DESCRIPTION

Generally, aspects of the invention are usable in connection with the processing and production of food products that include a hard component that is connected to or is surrounded by a soft matter component that is softer, weaker, and/or more fragile than the hard component. The hard component may be, in various embodiments, a nut, a seed, a pit/stone, a kernel, a legume, a pyrene, or other plant component that is connected to softer matter, such as fruit, vegetables, stems, capsules, shells, pedicels, or other soft plant tissue. Nuts, and specifically cashews, may be usable in connection with the production with this invention. In one embodiment, aspects of the invention may be usable for separation of any nut, seed, or other hard matter component from soft matter that is connected thereto. Examples (non-exhaustive) of other types of nuts, fruits, or plant tissue that may be processed may include apricots, peaches, mangos, and other fruits that contain a hard seed connected to or surrounded by fruit. Throughout the rest of this description, the term “nut” may be generally used to describe the hard component of the plant material. For example, for cashews, the nut describes the cashew nut of the cashew fruit, while soft matter describes the plant tissue (i.e. the cashew apple, juice, and possibly other matter) connected to the nut that is removed from the nut for cashew processing. Additionally, in another example, for peaches, the nut describes the pit or seed of the peach, while the soft matter describes the fruit portion of the peach that surrounds the pit or seed of the peach.

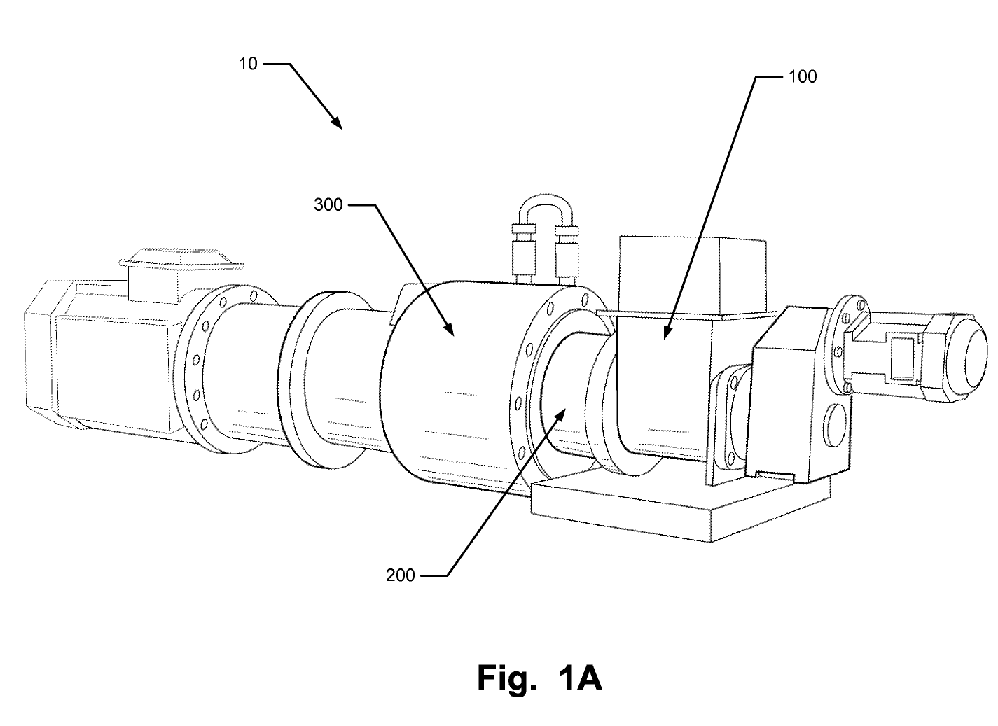

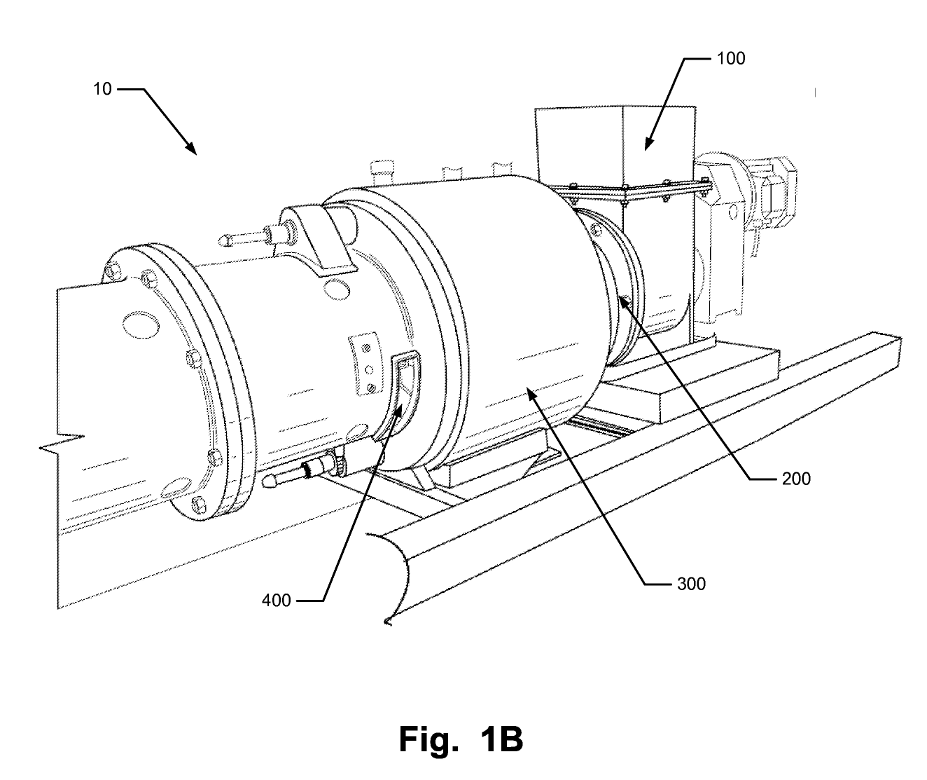

Aspects of the invention relate to a machine (or mechanical nut separator 10) that is usable for the processing of a nut and/or fruits, an example of which is shown in FIG. 1A. In specific aspects of this invention, the mechanical nut separator 10 may be utilized for the processing of a cashew nut. The mechanical nut separator 10 can reduce costs for cashew nut separation up to 25%, provide a yield improvement of 3-15%, and reduce the time from harvesting to processing (e.g. by several hours in some embodiments) verses current practice of removing the nut from the fruit during picking and transporting the fruit to the plant without a nut attached.

In general, the mechanical nut separator 10 may include an infeed portion 100, a first rotary module 200, a second rotary module 300, and a discharge portion 400. The mechanical nut separator 10 may also include additional structures to hold and support the mechanical nut separator 10. These structures may generally include a frame 20. The frame 20 may act as an anti-vibration structure mounted on a main bearing structure. The frame 20 may also include a switch panel housing electrical control and safety devices. The function of the nut separator 10 is described below specifically with respect to a cashew nut that is connected to a cashew apple, however it is understood that the nut separator 10 may generally be usable for separation of another type of nut from other types of soft matter connected thereto (which may include a fibrous component), or other purposes identified elsewhere herein.

As illustrated in FIGS. 1A and 1B, the mechanical nut separator 10 provides an efficient means to separate the cashew nut from the cashew apple. Generally, the cashew apple with a cashew nut attached is fed into the infeed portion 100 of the mechanical nut separator. The cashew apple with cashew nut attached may be fed into the infeed portion 100. The infeed portion 100 may then control the speed and meter the infeed of cashew apple and nuts towards the first rotary module 200. As the cashew apple and nuts enter the first rotary module 200 from the infeed portion 100, the first rotary module 200 crushes the cashew apple while also cutting the fibers attached to the nut without damaging the nut. The first rotary module 200 creates an inductive effect to further transport the crushed apple mass cut and removed from the nut into the following second rotary module 300. As the crushed apple and nuts enter the second rotary module 300, the second rotary module 300 passes the nuts with minimal damage through the rotor to the discharge portion 400 located at the end of the second rotary module 300. During their passage through module 300 many of the remaining tails on the nuts are cut away by the screen. As the nuts are passed to the discharge portion 400, the crushed apple is passed through the passages in the cylindrical walls of the second rotary module 300 and discharged as crushed fruit puree for further processing.

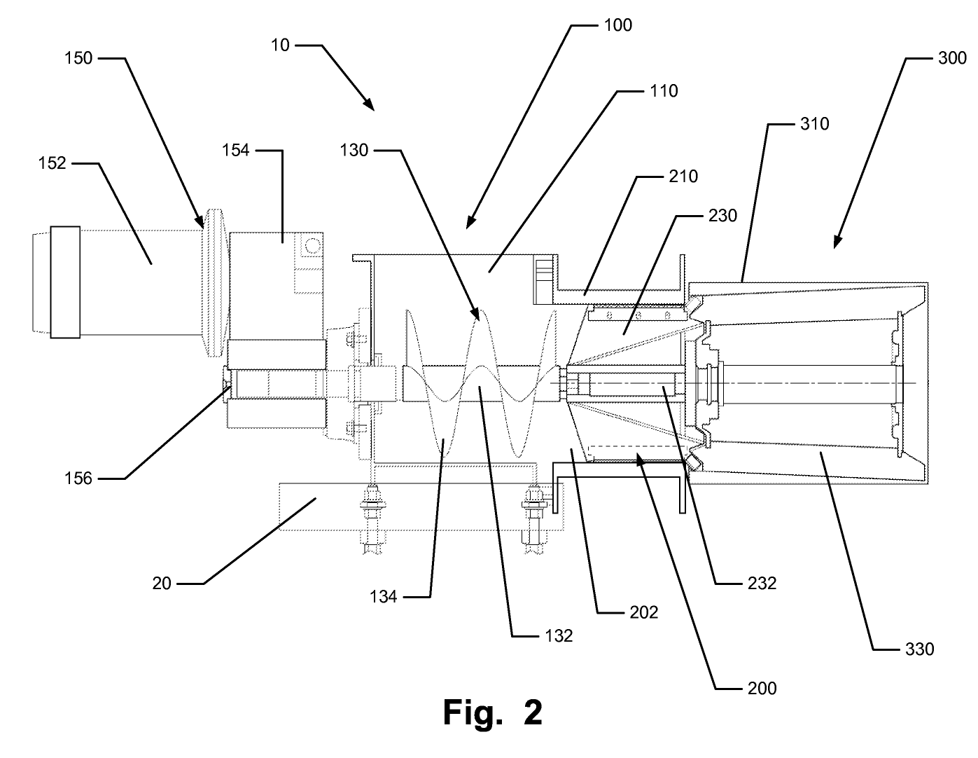

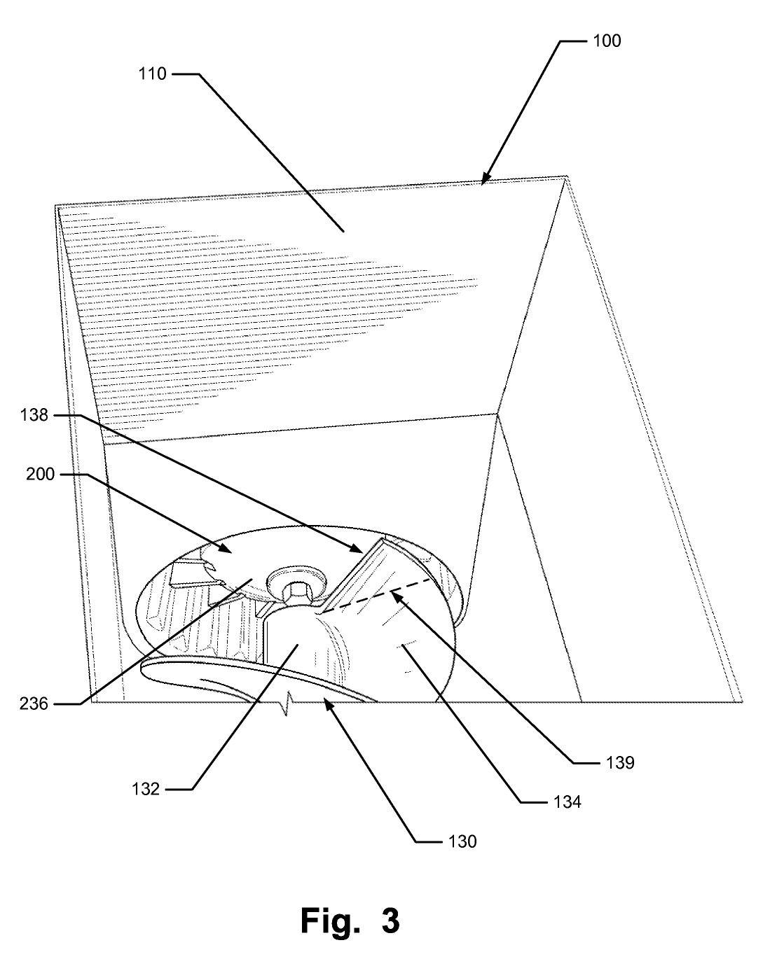

FIGS. 2 and 3 illustrate in more detail the infeed portion 100 of the mechanical nut separator 10. The infeed portion 100 may include a hopper 110, an auger assembly 130, and a motor assembly 150.

As illustrated in FIGS. 2 and 3, the hopper 110 may be rectangular in shape and designed to receive the cashew apples. The cashew apples may be fed into the hopper 110 by any number of various methods, such as hand fed by an operator, or dumped into the hopper 110 utilizing a large container. The cashew apples may also be fed into the hopper 110 utilizing more automated means, such as by a conveyor, or a feed elevator. The hopper 110 may include a front wall, a back wall, and two side walls. The hopper 110 may also be other shapes without departing from this disclosure, such as cylindrical, square, etc.

An ultra high-molecular-weight polyethylene (“UHMW”—also known as high-modulus polyethylene (HMPE) or high-performance polyethylene (HPPE)) lining may be installed inside the hopper walls. The UHMW lining may be utilized to close up any gaps between the auger assembly 130 and the hopper walls. Closing these gaps may help to reduce pinching of the cashew apples and nuts between the auger assembly 130 and the hopper walls. The pinching of the cashew apples and nuts may cause the nuts to be damaged.

At various times, based on the maintenance and/or operating schedule, the hopper 110 may be required to be cleaned out. Many different features may be utilized to help with the cleaning out of the hopper 110. First, the hopper 110 may also include a hatch at the bottom or invert of the hopper 110. The hatch may be water-tight. The hatch may be opened such that the hopper 110 can be cleaned through the hatch.

Additionally, the hopper 110 may include a separate cleanout door. The cleanout door may be utilized by the operator and/or provide maintenance access. Additionally, the hopper 110 may also include a level transmitter required for the overall production line control to be utilized by the operator and with the cleanout door. The hopper 110 may also include a removable spray device to be utilized with the cleanout door and to clean the hopper 110.

As illustrated in FIGS. 2 and 3, the auger assembly 130 may be attached to the hopper 110, and located such that the auger assembly 130 is located at the bottom of the hopper able to receive the cashew apples from the hopper. The auger assembly 130 provides the infeed movement of the cashew apples from the hopper towards and into the first rotary module 200. Not only does the auger assembly 130 meter the infeed of the cashew apples towards the first rotary module 200, but the auger assembly 130 also begins to soften the flesh of the cashew fruit and liberate the juice within the fruit without damaging the cashew nuts. The auger assembly 130 may include a feeding shaft 132, and a feeding screw 134. Generally, a mounting support attached to one of the walls of the hopper may be utilized to support and provide access to the hopper for the feeding shaft 132. The mounting support may be attached utilizing bolts and or screws as a means to attach the auger assembly 130 to the wall of the hopper. There may be a bushing around the mounting support located at the hopper where the feeding shaft 132 enters the hopper. This bushing may provide a seal to the hopper at the feeding shaft 132. The mounting support may be attached to any of the walls of the hopper, but preferably will be attached to the rear wall of the hopper. The feeding shaft 132 may have sufficient length between the rear wall of the hopper and the beginning or start of the feeding screw 134 to create a larger area where the nuts will not get stuck and damaged.

As illustrated in FIGS. 2 and 3, the feeding screw 134 may be a counterclockwise-turning auger installed on the feeding shaft 132. The feeding shaft 132 and feeding screw 134 turn at a speed of 15 to 175 rotations per minute (RPM) in one embodiment. In another embodiment, the feeding shaft 132 and feeding screw 134 may turn at approximately 10 to 90 RPM. In one embodiment, a differential rotation speed is maintained between the feeding shaft 132 and the rotating structure 230 of the first rotor module 200, which can reduce damage to the nuts by reducing the residence time for the nuts to flow through the machine and avoid crushing of the nuts against the rotating structure 230 by the auger assembly 130. In another embodiment, the auger assembly 130 may rotate at the same speed as the first rotary assembly 200, and in a further embodiment, the auger assembly 130, the first rotary assembly 200, and the second rotary assembly 300 may rotate at the same speed, and may be driven by a single motor. The feeding screw 134 may also include a welded bead or similar configuration located on the periphery of the feeding screw 134. The welded bead on the feeding screw 134 may help to close the gap between the end of the feeding screw 134 and the inside walls of the hopper, thereby eliminating a pinch point where the nuts can get caught and get damaged. In one embodiment, the gap may be less than 50% of the smallest diameter of the nut, such as about 3/16″ in one embodiment adapted for cashew processing. Additionally, in one embodiment, the gap between the feeding screw 134 and the leading edges of the rotating profile structure 230 of the first rotary module 200 may be less than the smallest diameter of the nut, or less than 50% of the smallest diameter of the nut, in order to avoid nuts being lodged between the feeding screw 134 and the leading edges of the rotating profile structure 230, which can result in damage.

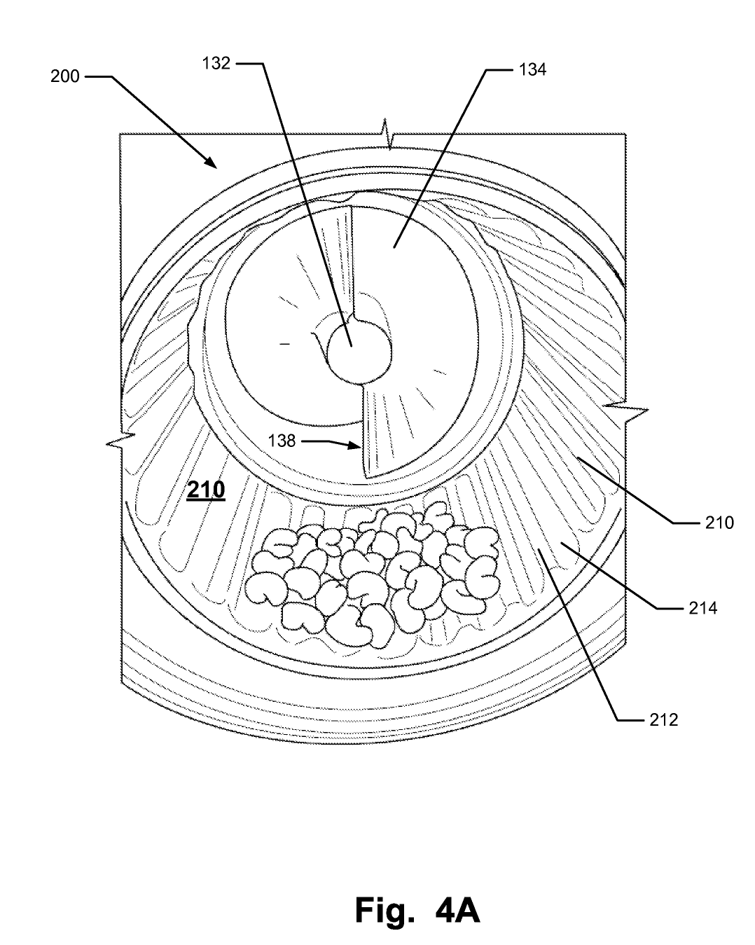

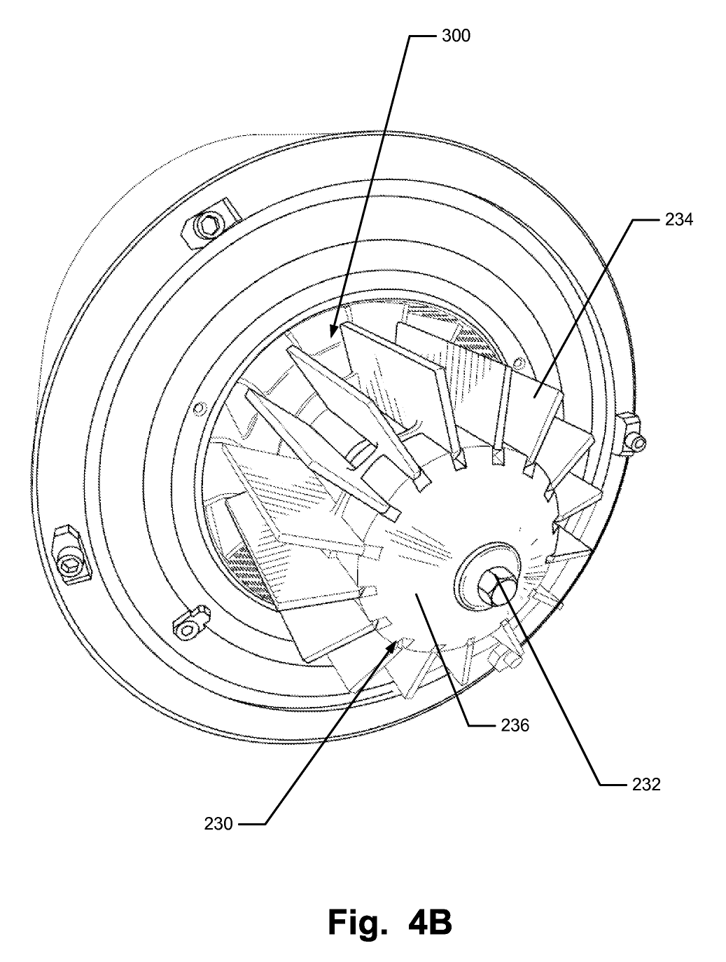

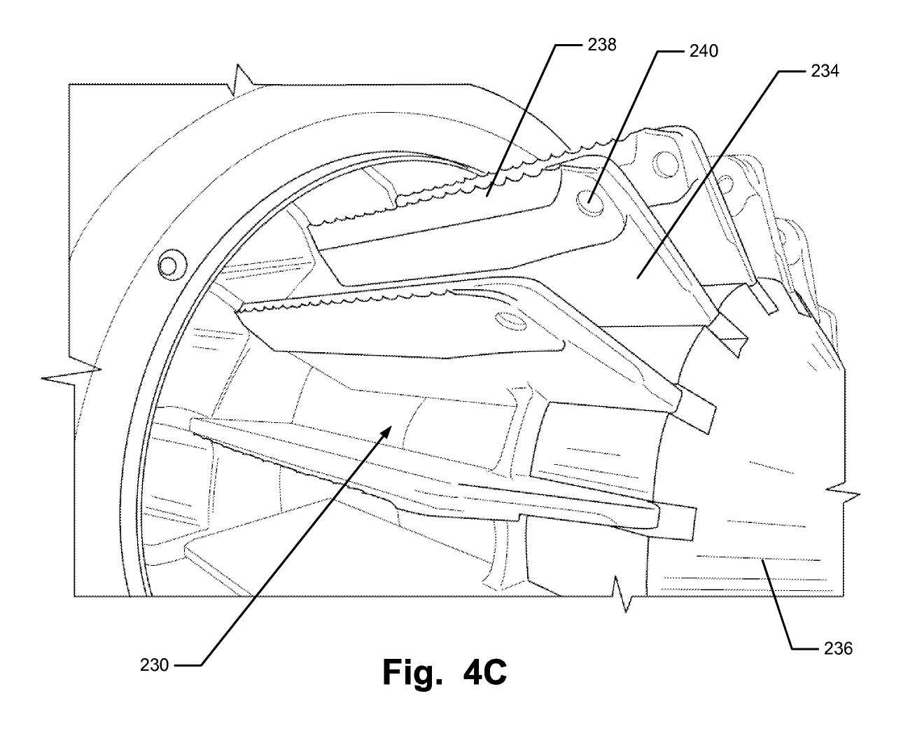

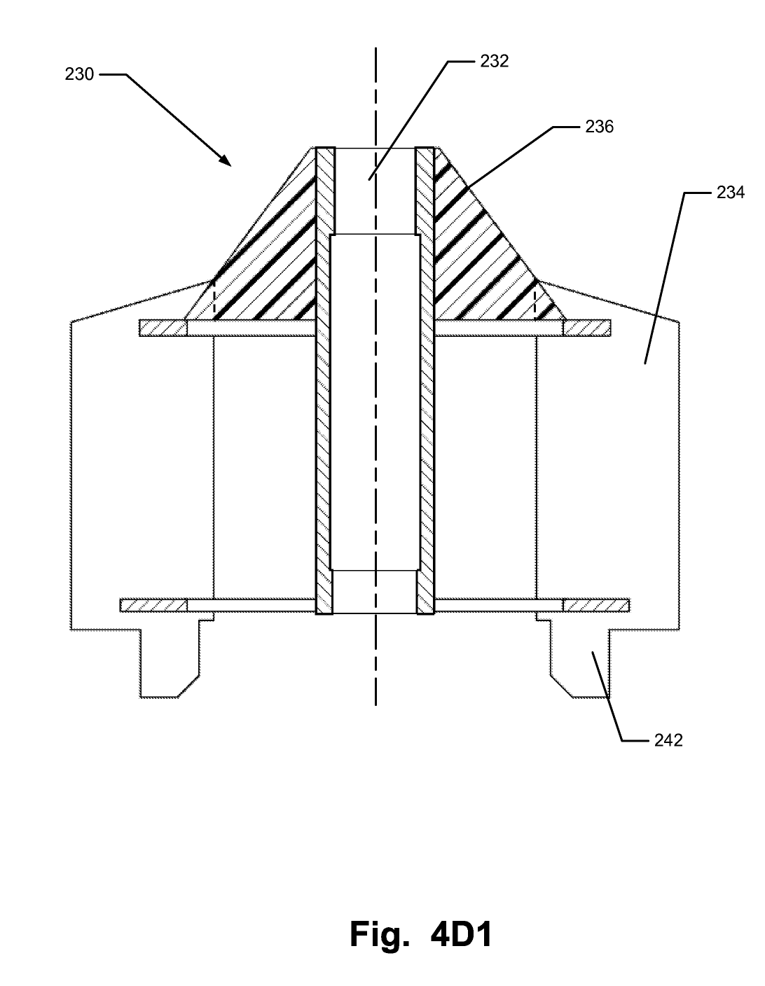

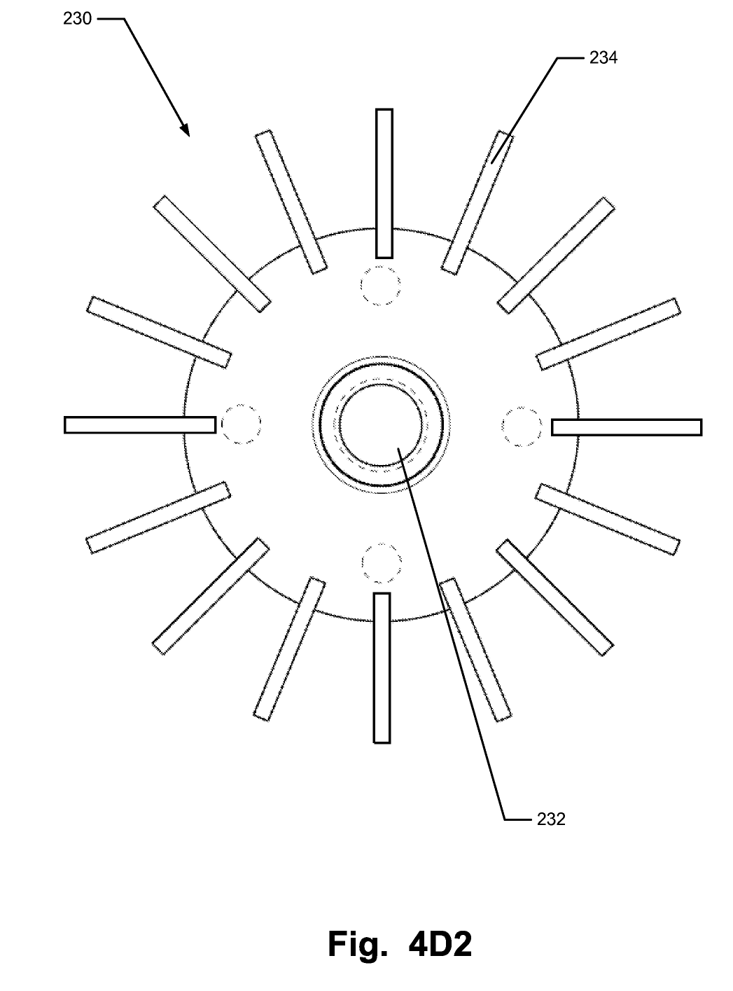

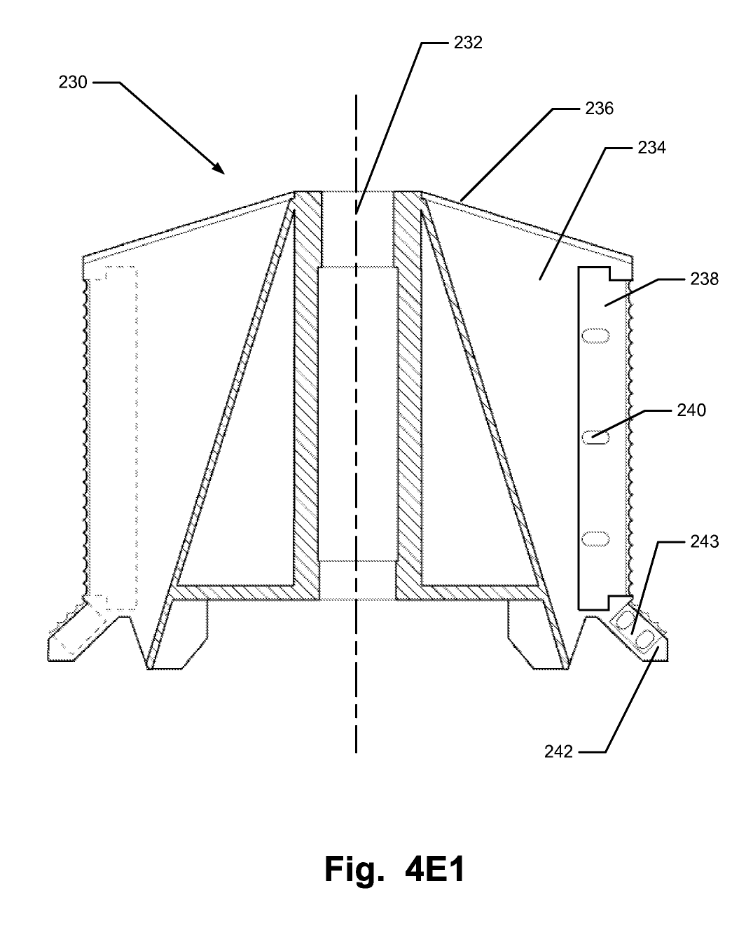

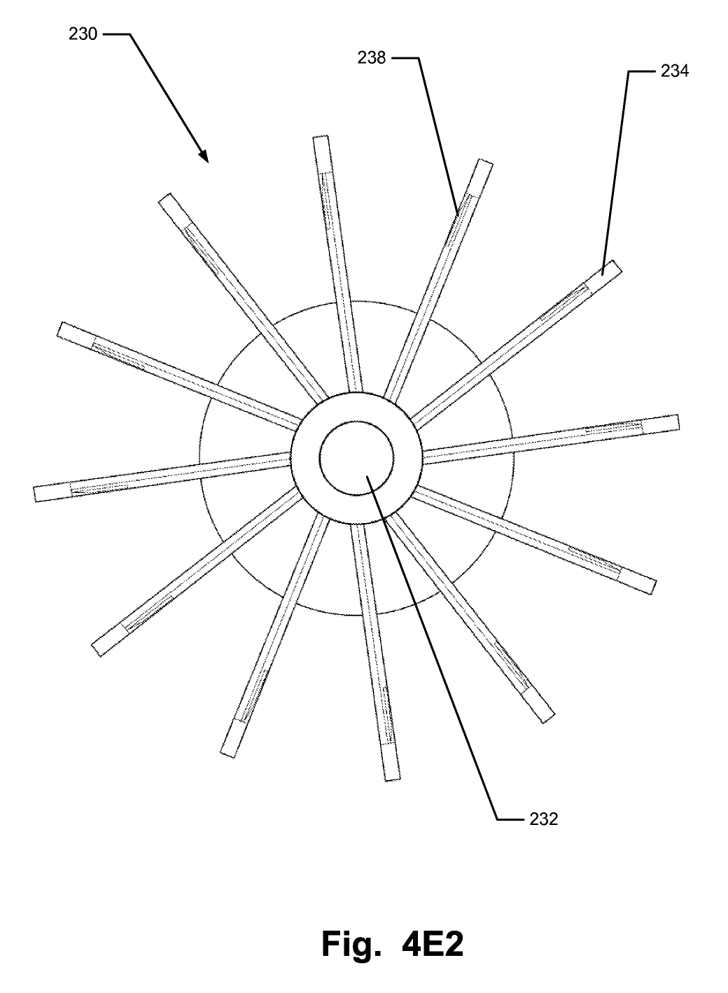

In one embodiment, the end of the feeding screw 134 may be swept rearwardly and/or may include a non-linear profile. The non-linear profile may replace a flat-line profile 138 (as illustrated in FIG. 4A) on the feeding screw. FIG. 3 illustrates one example of such a modification, showing the flat line profile 138 of the feeding screw 134 as illustrated in FIG. 4A, as well as a modified, non-linear or swept profile 139. The non-linear profile on the end of the feeding screw provides an improved feeding action towards the first rotary module 200 by generating a constant gap between the swept leading edge of the first rotary module 200 (as will be explained in more detail below) and the swept trailing/discharge edge of the feeding screw 134. Providing a constant gap between the first rotary module 200 and the feeding screw 134 helps to eliminate pinching the nuts and damaging the nuts at or near the entrance of the first rotary module 200.

In an alternate embodiment, the feeding shaft 132 and feeding screw 134 may be replaced by a pump to pump the whole cashew apples towards the first rotary module 200. The pump may be a large cavity pump or a positive displacement pump as required. Similarly to the feeding shaft 132 and feeding screw 134, the pump may be attached to the rear wall of the hopper such that when the cashew apples are fed into the hopper, the cashew apples as a whole are pumped and pushed towards the first rotary module 200.

In another alternate embodiment, the feeding shaft 132, the feeding screw 134, and the first rotary module 200 may be one combination, integral piece. This piece would help to eliminate damage to the nuts that may occur in the transition area between the feeding screw 134 and the first rotary module 200.

In another alternative embodiment the feeding system can be mechanically separate from the first rotary module 200 and the first rotary module 200 mechanically not connected with the downstream rotor system. Pumps, flumes, belts or other methods of transporting the fruit and nuts between sections can be used.

Lastly, the infeed section 100 includes a motor assembly 150. The motor assembly 150 may be attached to the feeding shaft 132 to turn and rotate the feeding shaft 132 and feeding screw 134. The motor assembly 150 may include a motor 152, a gearbox 154 attached to the motor 152, and a gripping washer 156. The gripping washer 156 provides a secure connection between the motor assembly 150 and the feeding shaft 132.

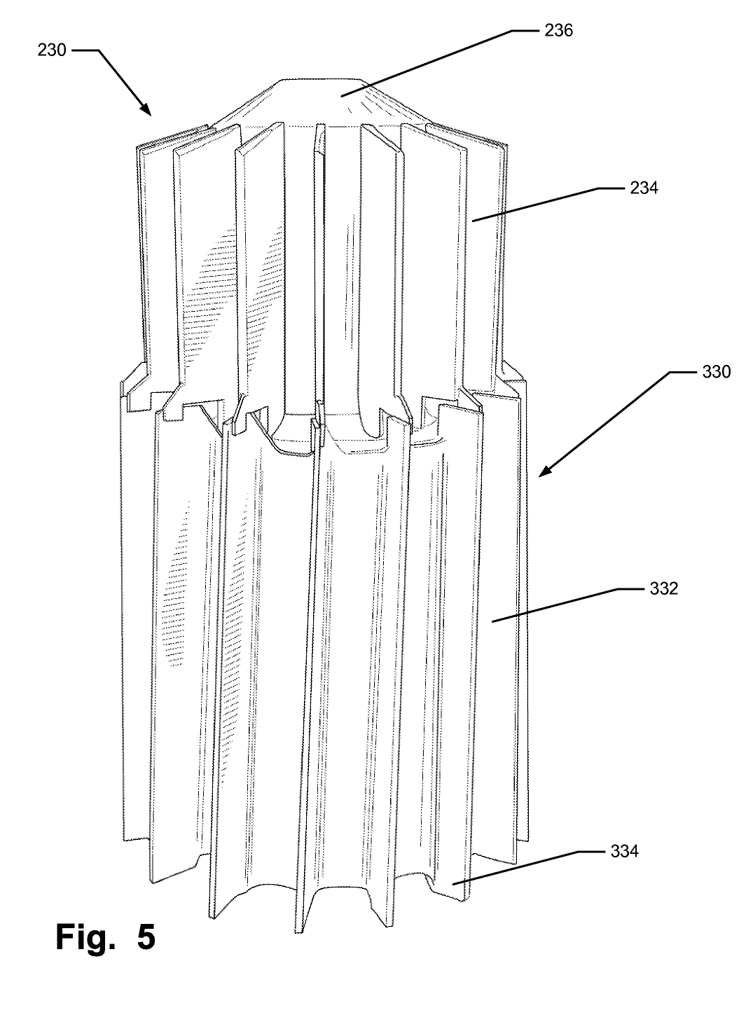

As illustrated in FIGS. 4A through 5, the first rotary module 200 includes a static profile structure 210 and a rotating profile structure or rotor or rotor assembly 230. The rotating profiled structure 230 may be attached to a motor or motor gearbox capable of rotating the rotor the required speeds. Generally, the first rotary module 200 crushes or smashes the soft matter (e.g. the apple) and by using knives cuts away the fiber from the nut to form a crushed apple mass that includes pulp and potentially other components, such as a fibrous component, some of which may still be connected to the nut, as well as juice and/or other components. The first rotary module 200 also creates an inductive effect to further transport the crushed apple mass into the following second rotary module 300. The cashew apples and nuts flow in a chamber 202 of the first rotary module 200 which is defined by the internal surface of the stator 210, such that the apples and nuts pass between the internal surface of the static profile structure 210 and the external surface of the rotating profile structure 230. The rotating profile structure 230 presses the mass of the cashew apples and nuts traveling in the cavity 202 with a rotary motion which by centrifugal effect keeps the mass pressed against the stator 210, forcing the mass to follow the motion of the rotating profile structure 230 and smashing/crushing the cashew apples against the stator 210. Generally, the maximum space between the edges of the vanes 234 and the static profile structure 210 is smaller than half the diameter of the nuts so that the nuts cannot pass or become wedged between the vanes 234 and the static profile structure 210, such as up to approximately 1/16″ or up to approximately ⅛″ in one embodiment that may be useful for processing cashews. In one embodiment, the gap between the edges of the rotating profile structure 230 and any knives 238 attached to the rotating profile structure 230 and the static profile structure 210 is a minimum distance to prevent mechanical contact, such as up to approximately 1/16″ or up to approximately ⅛″. Due to the centrifugal motion, the nuts rest against the edges of the vanes 234 and any portions of the cashew apple still connected to the nut (e.g. fibers) pass into the knives 238 between the vanes 234 and the static profile structure 210 to assist in cutting off the fibers, as described below.

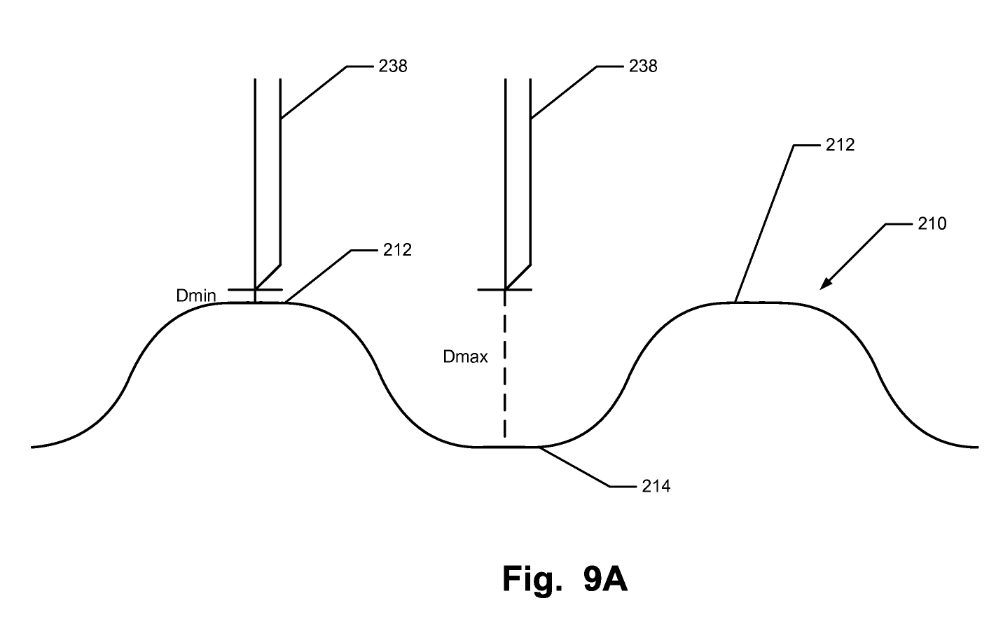

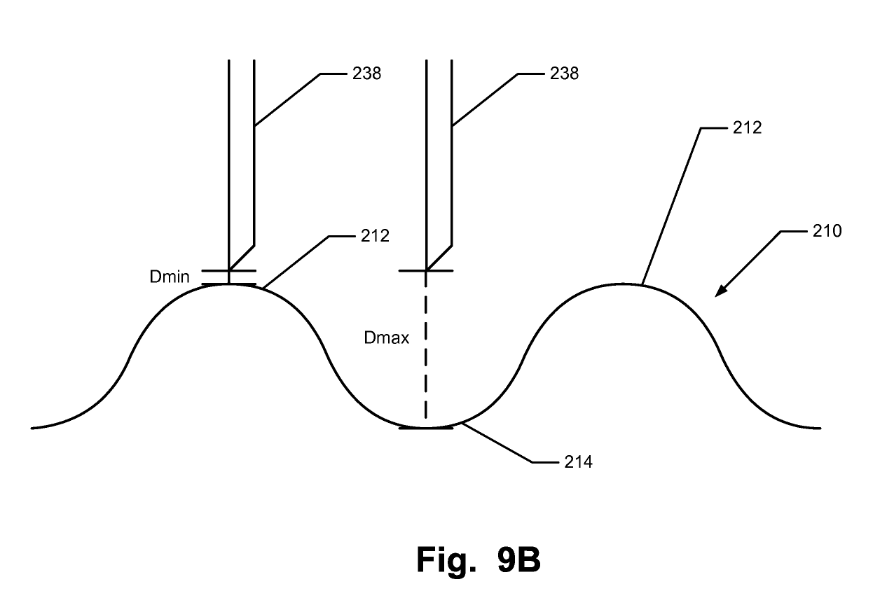

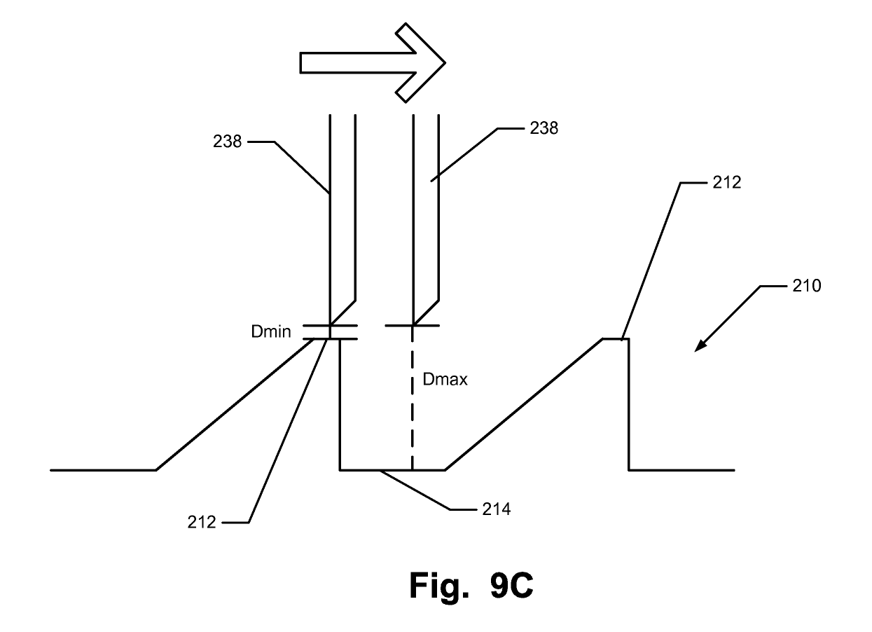

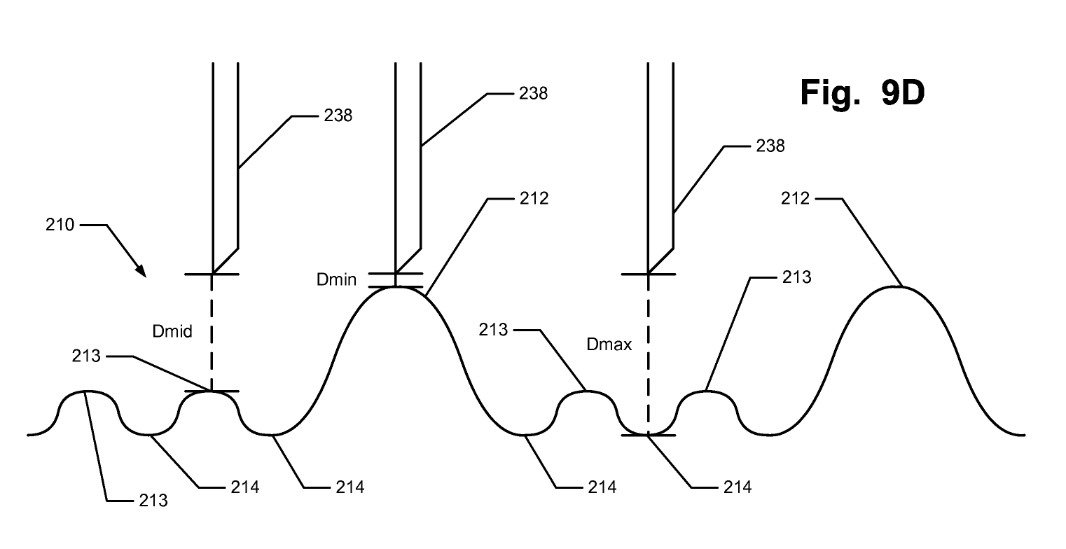

As illustrated in FIG. 4A, the static profile structure 210 is generally defined by a cylindrical chamber 202 surrounding the rotating profile structure 230. The static profile structure 210 includes an internal surface that is defined by different textures with a plurality of projections 212 which extend along the internal surface of the static profile structure 210, with troughs 214 defined between the projections 212. As illustrated in FIG. 4A, the projections 212 may be defined by pitch, profile, and amplitude. In one embodiment, the projections 212 and the troughs 214 have beveled and rounded shapes. In other embodiments, the profile of the static profile structure 210 may be different. FIGS. 9A-9D schematically depict several different profiles for the static profile structure 210. FIGS. 9A-9D also illustrate the maximum clearance (Dmax) and the minimum clearance (Dmin) between the knives 238 (or the free ends of the vanes 234, e.g. if no knives are present). Generally, the maximum clearance (Dmax) occurs between the knives 238 and the bottoms of the troughs 214, and the minimum clearance (Dmin) occurs between the knives 238 and the tops of the projections 212. FIG. 9A depicts one embodiment of a static profile structure 210 similar to the static profile structure 210 shown in FIG. 4A, with the projections 212 having relatively flattened tops and the troughs 214 having relatively flattened bottoms. FIG. 9B depicts another embodiment of a static profile structure 210 with the projections 212 having rounded tops and the troughs 214 having rounded bottoms. FIG. 9C depicts another embodiment of a static profile structure 210 with projections 212 that are asymmetrical in structure, having ramps 212A on the leading edges of the projections 212 (facing the movement direction of the knives 238, which is shown by arrows) and cliffs 212B on the trailing edges of the projections 212. The troughs 214 are relatively flat in this embodiment. FIG. 9D depicts another embodiment of a static profile structure 210 that has two different types of projections, including large projections 212 and small projections 213 that have relatively larger and smaller amplitudes, respectively. The projections 212, 213 are separated by troughs 214 of equal depth, although troughs 214 of unequal depth could be incorporated in other embodiments. The clearance (Dmid) between the smaller projections 213 and the knives 238 is also shown in FIG. 9D, and this clearance (Dmid) is between the maximum and minimum clearances (Dmax, Dmin). The troughs 214 and projections 212 of the static profile structures 210 shown in FIGS. 9A-9D are formed in continuously repeating patterns, however in other embodiments, a random or non-repeating pattern may be used, or a more complex repeating pattern (e.g. FIG. 9D). In further embodiments, other static profile structures 210 may be used.

As illustrated in FIGS. 4B through 4E2, the rotating profile structure 230 may include a shaft 232, a set of vanes 234, and a cone 236. In one embodiment, the first rotary module 200 may turn at approximately 200-1600 RPM, or approximately 600-1200 RPM, or about 900 RPM. This RPM range can provide excellent performance in a nut separator 10 as shown in FIGS. 1-4C, when used in processing cashew nuts and apples. It is understood that different rotational speeds may be used in different embodiments involving the same or different processing equipment and/or uses. In one example, scaling up to a larger device may change the most effective rotational speed of the first rotary module 200, and the optimal speed may depend at least partially on the diameter of the first rotary module 200. In other embodiments, the first rotary module 200 may turn at approximately 200 to 1600 RPM, or approximately 200-1400 RPM, or approximately 200-900 RPM, or approximately 300 to 600 RPM, or approximately 200 to 800 RPM, or approximately 600 RPM. The vanes 234 may be attached at their bases to the shaft 232 and extend outwardly toward the stator 210 from the shaft 232. The ends of the vanes 234 furthest from the base may be referred to as the free edge.

As illustrated in FIG. 4B, the cone 236 may be the leading edge or face of the first rotary module 200 from the infeed section 210. In one embodiment (e.g. FIGS. 4B and 4E1), the cone 236 may be integrally formed with the body of the rotating profile structure 230, having the shaft 232 integrally defined therethrough. The vanes 234 may also be integrally formed as part of this structure in one embodiment, or may alternately be separate pieces connected to the body. Such an integrally formed rotating profile structure may be formed of stainless steel, or may be formed of another material in another embodiment. The cone 236 may be made of a separate piece in another embodiment, and may also be made of a different material, such as an ultra high-molecular-weight polyethylene (“UHMWPE”), as shown in FIG. 4D1. A separate-piece cone 236 as shown in FIG. 4D1 may also be removable/detachable from the rotating profile structure, such as to facilitate cleaning Generally, the cone 236 may define a surface that is conical in shape and may form an angle of approximately 15° to 75° with the rotational axis of the rotating profile structure 230 as defined by the shaft 232 (i.e. when viewed in cross-section), such as FIGS. 4D1 and 4E1. The rotational axis is indicated by a broken line in FIGS. 4D1 and 4E1. Without departing from the invention, the cone 236 may be any number of different various conical shapes that have different angles to further augment the passage of the cashew apples and nuts. The cone 236 may be in the shape of and defined as a bullet-nose design which assists the transportation of the cashew nuts to the vanes 234. The frontal area of the first rotary module 200 and cone 236 is to be minimized. Additionally, the cone 236 may include a beaded swirl to create even more flow through of the cashew nuts to the vanes 234. The cone 236 may further include slots such that the vanes 234 intersect with the cone 236. These slots should be designed and cut into the cone 236 without creating snag points or pinch points for cashew apple and cashew apple fibers to catch into and create a jam.

As illustrated in FIGS. 4B and 4C, the vanes 234 are designed to crush the cashew apple that still has a nut attached, and creates an inductive effect to transport the crushed cashew apples and nuts into the following second rotary module 300 without relying solely on the volume of soft matter pushing the cashew apples and nuts forward. In an example embodiment, there may be twelve vanes 234 utilized with the first rotary module 200. Other numbers of vanes 234 may be utilized without departing from this invention, for example, ten or eight vanes 234, or even more, such as fourteen or sixteen vanes 234. Generally, the number of vanes 234 installed with the first rotary module 200 should be selected with the purpose of creating wide enough inter-vane spacing for the nuts to pass through without getting damaged. In the embodiment shown in FIGS. 2-4E1, the vanes 234 extend substantially straight (i.e. radially) outwardly from the body of the rotating profile structure 230. In another embodiment, shown in FIG. 4E2, the vanes 234 may extend outwardly in a slightly angled or tangential direction.

The vanes 234 may also include additions to the outside edges of the vanes 234 to create a larger transport cavity for the nuts. The additions to the outside edges of the vanes 234 may be formed by using round rod or rectangular pieces of stainless steel. The additions to the outside edges of the vanes 234 may effectively reduce the resistance that the cashew apple encounters to enter the first several inches of the first rotary module 200 which then minimizes the crushing damage to the nuts. Additionally, as illustrated in FIG. 4E1, the leading edges of the vanes 234 may be trimmed or beveled with a swept wing design in one embodiment. The swept wing design of the leading edges of the vanes 234 may create an easier passage for the cashew apples and nuts into the spaces and cavities between the vanes 234. In one embodiment, the angle between the leading edge and the free edge of each vane 234 may be greater than 90°.

The first rotary module 200 may include a number of additional features to help eliminate and minimize the crushing and damage of the cashew nuts. One feature is that the first rotary module 200 may include two radial stiffeners. By reducing and/or minimizing the outside diameter of the radial stiffeners, the radial stiffeners may create a bigger passage area for the nuts, thereby minimizing the damage to the cashew nuts.

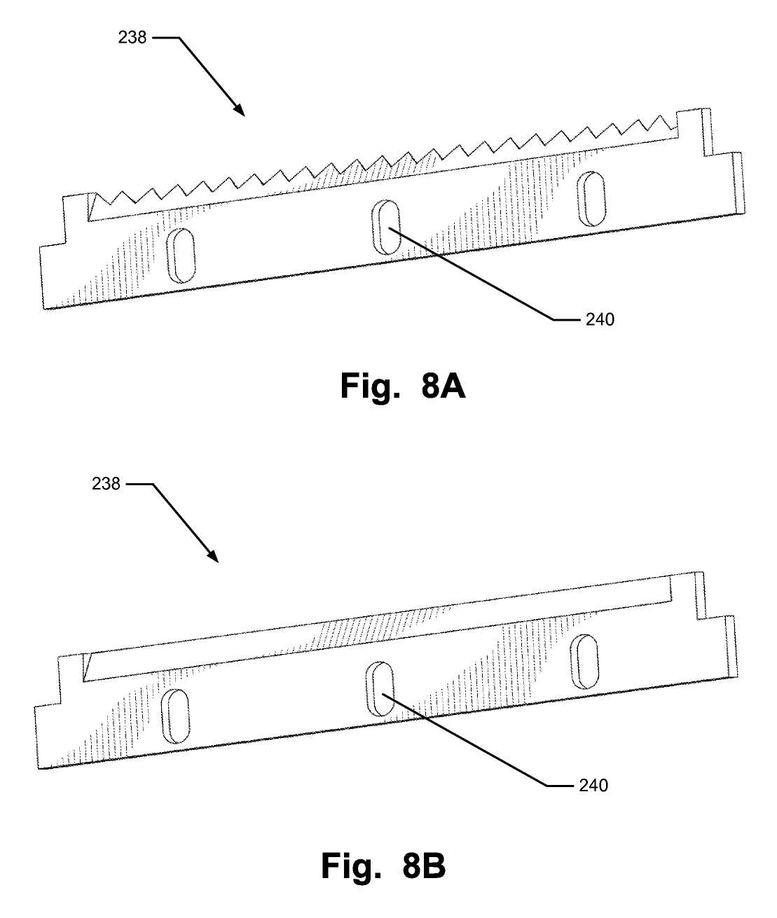

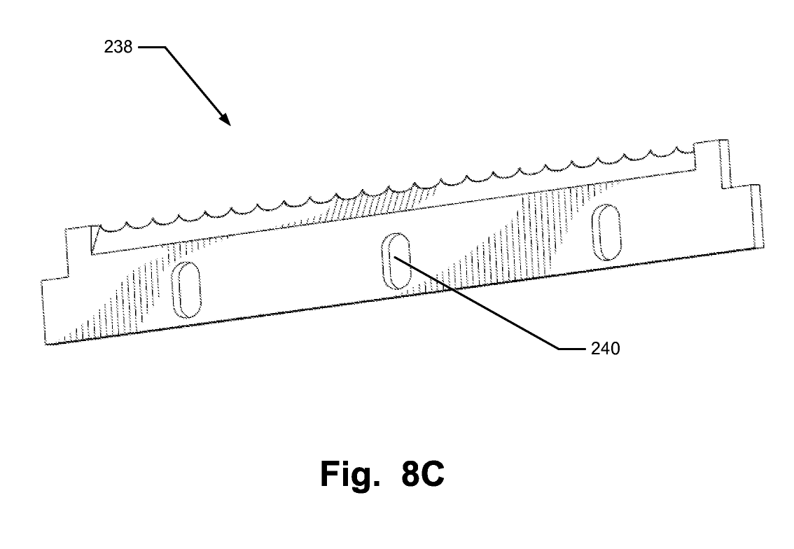

As illustrated in FIGS. 4C and 4E1, the vanes 234 may include knives 238 connected to the free ends of the vanes 234 in one embodiment. The knives 238 may create a cutting surface for the purpose of cutting cashew apple fiber tails off of the nuts as they pass through the first rotary module 200, without damaging the nuts. As described above, in one embodiment, the nuts tend to rest against the vanes 234 proximate the interior surface of the stator 210, with the attached fibrous portions extending through the gaps between the free edges of the vanes 234 and the stator 210. As the nuts pass forward through the first rotary module 200, the fibrous portions slide against the knives 238, cutting them from the nuts. The knives 238 may be of a scalloped design, as illustrated in FIGS. 4C and 4E1. FIG. 8C also illustrates a knife 238 having a scalloped design. In other embodiments without departing from this invention, the knives 238 may be serrated design as illustrated in FIG. 8A or straight knives design as illustrated in FIG. 8B. The knives 238 may be attached to the vanes 234 in a variety of configurations. For example, in the embodiment illustrated in FIG. 4E1, the knives 238 are removably attached to the vanes 234 using fasteners received in keys 240 on the ends of the knives. The keys 240 allow the knives 238 to be adjustable such that the clearance between the knives and the stator 210 is adjustable. For maintenance purposes, the knives 238 in this embodiment may be easily removable and replaceable when the knives need to be either sharpened or replaced. A maintenance jig may be utilized for any shop personnel when the first rotary module 200 needs to have the knives 238 changed out. In another embodiment, the knives 238 may be permanently or semi-permanently connected to the vanes 234, such as by welding, brazing, adhesive bonding, etc. In a further embodiment, the knives 238 may be blades that are integrally formed as part of the free edge of each vane 234. The knives 238 may be installed on all of the vanes 234. In another embodiment without departing from this invention, the knives may be installed on a defined number of vanes less than all of the vanes 234.

In the embodiments illustrated, e.g., in FIGS. 4C and 4E1, the knives 238 have blades that are generally aligned and/or parallel to the vanes 234. In other embodiments, the knives 238 or portions of the knives 238 (e.g. the blades) may be oriented in a different direction. For example, at least the blade of the knife 238 may be oriented to be at least partially sideways-facing in the leading direction, or in other words, in the direction that the first rotary module 200 is rotating. The knives 243 on the tail fins 242 may also be oriented in similar manners in one embodiment. Other orientations and configurations of the knives 238, 243 are possible in other embodiments. A knife 238, 243 with a blade that is oriented or configured differently from the knives 238, 243 shown in FIGS. 4C and 4E1 may still have similar clearances and tolerances as described elsewhere herein, such as the clearances shown and described with respect to FIGS. 9A-9D.

Additionally, as illustrated in FIGS. 4D1 and 4E1, the vanes 234 may also each include a tail fin 242 extending from the vane 234 proximate the rear or trailing end of the vane 234. The tail fin 242 may be triangularly shaped, having a leading edge that angles upwardly and outwardly from the free edge of the respective vane 234. The tail fin 242 may close any gaps in the transition area between the first rotary module 200 and the second rotary module 300. The tail fin 242 may also have knives 243 connected to the leading edges to create another cutting surface to remove remaining cashew apple fiber tails from the nuts without damaging the nuts. Similar to the knives 238 of the vanes 234, the knives 243 of the tail fins 242 may be of a scalloped design, a straight cutting design, a serrated design, or another design, and may be removably connected, permanently connected, or integrally formed with the leading edges of the tail fins 242, and/or may have any other configuration described above with respect to the knives 238. The tail fins 242 may be welded to the vanes 234. Additionally, the tail fins 242 may be replaceable.

As illustrated in FIGS. 2, 5, 6A and 6B, following the first rotary module 200 is the second rotary module 300. The pulp, nuts, and other components of the cashew apple exit the first rotary module 200 and enter the second rotary module 300. The second rotary module 300 then passes the nuts through the rotor with minimal damage to the discharge portion 400 located at the end of the second rotary module 300. Generally, the second rotary module 300 may turn at 200 RPM to 900 RPM in one embodiment or approximately 200 to 1400 RPM in another embodiment. In other embodiments, the second rotary module 300 may turn at approximately 200 to 1600 RPM, or approximately 300 to 600 RPM, or approximately 200 to 800 RPM, or approximately 600 RPM. The second rotary module 300 includes a screen 310 and a rotor or rotor assembly 330. The rotor 330 may be attached or otherwise operably connected to a motor or motor gearbox capable of rotating the rotor 330 the required speeds. Additionally, the same motor that is connected to the rotating profile structure 230 may be rotationally connected to the rotor 330, thereby rotating both the rotating profile structure 230 and the rotor 330 the same rotational speeds. Further, the chamber 202 of the first rotary module 200 and the chamber 302 of the second rotary module 300 may form a single, continuous chamber in one embodiment, such as shown in FIG. 2. This configuration may allow the nuts (or at least some of the nuts) to remain in substantially the same orientation from the first rotary module 200 to the second rotary module 300. In another embodiment, the first rotary module 200 and the second rotary module 300 may be separate from each other, and output from the first rotary module 200 (e.g. pulp, juice, and nuts or other hard matter) may be removed and loaded into the second rotary module 300 for further processing.

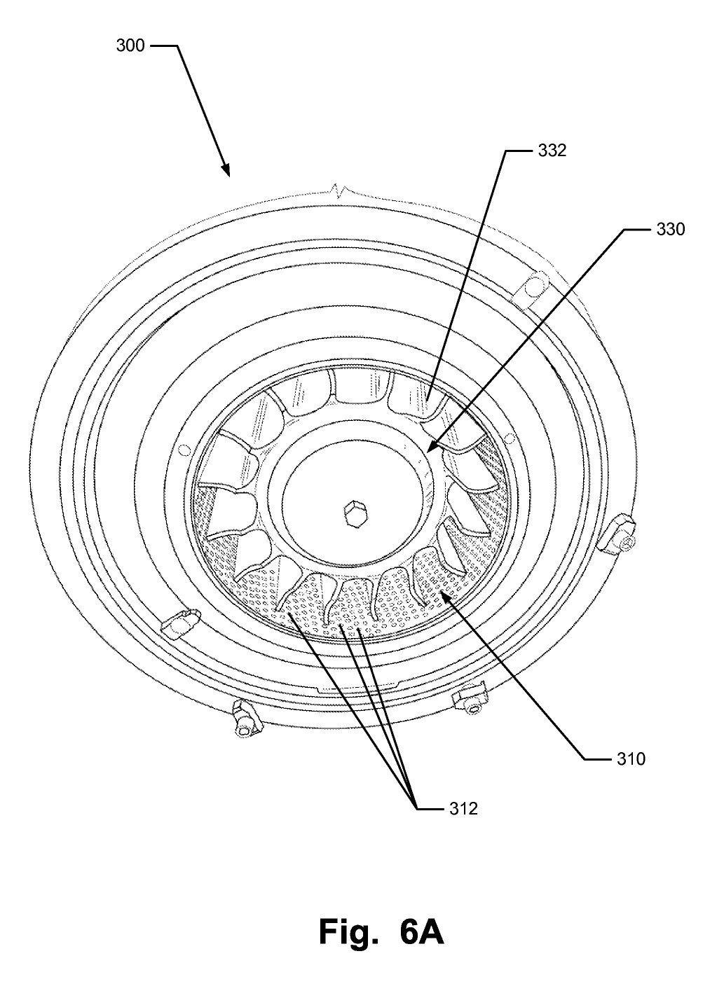

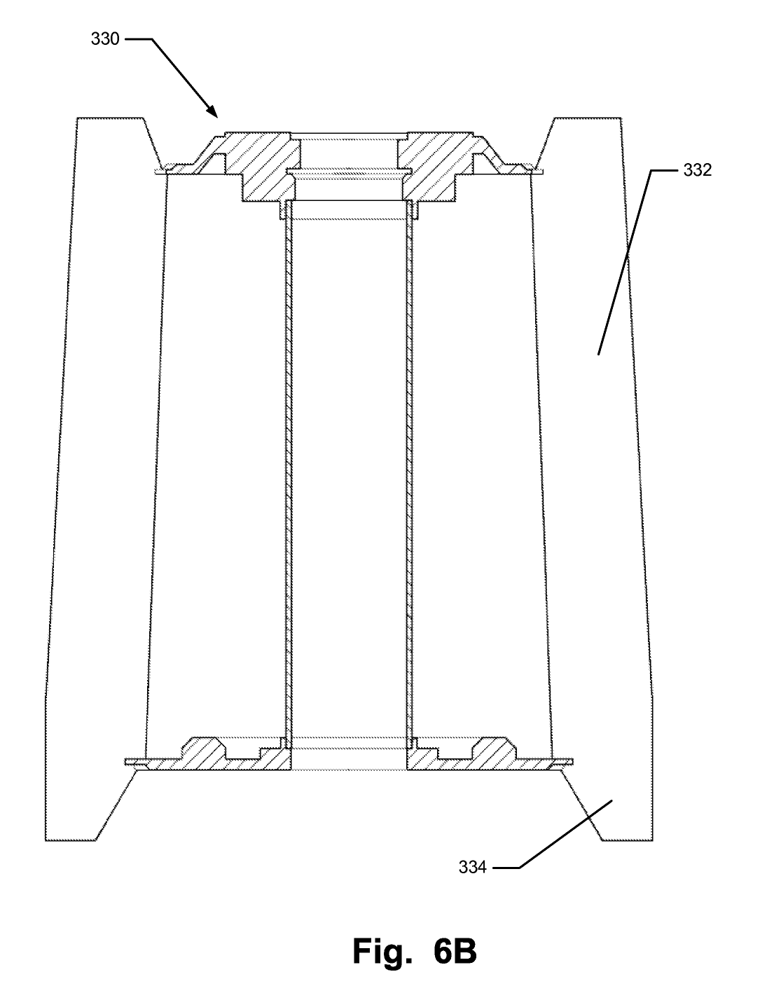

As illustrated in FIG. 6A, the screen 310 is cylindrical-shaped and surrounds the rotor 330 to define a chamber 302. The screen 310 includes a number of passages 312. The screen passages 312 should be large enough that the nut will not pass through them but not so large that the nut can be pushed into an opening and the surface of the nut shaves. The pulp, juice, and other matter produced from crushing the cashew apples should be able to fit through the screen passages 312. Additionally, the screen passages 312 may be in the pattern of circles, slots, ellipses and/or other shapes without departing from this invention. The screen passage 312 pattern may be optimized to get maximum nut separation from the cashew apple. In an exemplary embodiment, the screen passages 312 may be circular with a 0.25 inch diameter. In another exemplary embodiment, the screen passages 312 may be ellipses that include a 10 to 45 degree angle, ½ inch by 1 inch in length. The screen openings should be large enough to allow the crushed fruit skin and pulp to easily pass through the openings while not so large that the nut's surface would be shaved as the nuts are pushed into the passages by centrifugal and mechanical forces and then moved out of the passages by the rotor paddles. In one embodiment, the passage sizes should be no larger than 50% (or no larger than 25%) of the smallest diameter or dimension of the nut and not so small that crushed fruit cannot pass through the passages and therefore gets carried out of the machine at the nut discharge opening. Other dimensions and shapes may be utilized for the screen passages 312 without departing from this invention. The pulp, juice, fruit puree, and other soft matter that is pushed through the passages can be recovered for later use in one embodiment, or may be discarded as waste in another embodiment. For example, in one embodiment, the pulp, juice, fruit puree, and other soft material are collected separate from the hard material by using a chute positioned to direct them to a trough, container or other receptacle suitable for holding a juice liquid with pulp and that is cleanable. From the receptacle, the juice liquid with pulp can flow (e.g. by gravity, being mechanically pumped, and/or other means) to another location for further processing desired for the type of product being produced. This further processing can be finishing, decanting, pasteurization, evaporation, and/or other processes practiced to transform fruit juices, pulp, fruit puree and other soft material into desirable products. Thus, in one embodiment, the machine 10 may produce little or no waste material, as the hard matter output and the soft matter output may both be usable as products or to produce further products (e.g. with further processing necessary in many circumstances).

As illustrated in FIGS. 5, 6A, and 6B, the rotor 330 includes a minimum number of rotor paddles 332 to speed the nut passage through the second rotary module 300. The number of rotor paddles may be optimized by utilizing the minimal amount of rotor paddles while providing minimal to zero nut damage. In an embodiment, the rotor 330 includes 12 rotor paddles 332. The leading edges of the rotor paddles 332 may be spaced at least 0.5 inch from the entry end of the second rotary module 300 in one embodiment, and may be spaced at least 1 inch or at least 2 inches in other embodiments. In another embodiment, the rotor includes 16 rotor paddles 332. In a further embodiment, each of the rotor paddles 332 is generally aligned with one of the vanes 234 of the first rotary module 200, and the number of rotor paddles 332 is the same as the number of vanes 234. Additionally, in one embodiment, the leading ends of the paddles 332 are positioned very closely to the rear ends of the vanes 234, such as having a spacing of 1/16 inch or less in one example embodiment or even abutting in another embodiment, to form a seamless transition. As seen in FIG. 5, the leading ends of the paddles 332 are spaced closely (e.g. less than 1/16″) from the fins 242 of the vanes 234 in the illustrated embodiment, and may slightly overlap in the axial direction with the fins 242 and/or other portions of the vanes 234. The rotor paddles 332 may include a pitch or swirl on the rotor paddles 332. The pitch or swirl on the rotor paddles 332 may start from the leading edge of the rotor 330. The pitch or swirl may be designed to optimize and create the minimum retention time of the nuts within the second rotary module 300 without pushing the pulp, juice, etc. out of the discharge portion 400. In an embodiment of the invention, the pitch of the rotor paddles 332 may be from 15 to 35 mm. Further, at the transition from the first rotary module 200, the front or leading edge of the rotor paddles 332 may be swept backward slightly. The rotor paddles 332 may be swept back approximately 5-15 degrees with or without rounding at the screen 310 to thereby improve cashew apple and fiber passage and engagement with the screen. In one embodiment, the leading edges of the rotor paddles 332 are spaced at least 0.5 inches from the edge of the screen 310 and/or the edge of the chamber defined by the screen 310. The rotor paddles 332 may also have a slightly curvilinear profile in one embodiment.

In one embodiment, as illustrated in FIG. 6B, the rotor paddles 332 may include an extended tab 334. The extended tab may be located at the end of the rotor paddles 332 and may be designed to push or direct the nuts towards the discharge portion 400. The tabs 334 may be located on alternating paddles 332 in one embodiment. In another embodiment, such as the embodiment illustrated in FIG. 5, the tabs 334 may not be present, or may be trimmed. In another embodiment without departing from this invention, the extended tabs 334 on the rotor paddles 332 may be replaced with a rotating cage structure. The rotating cage directs the flow of the nuts towards the exit port of the discharge portion 400. Additionally, the rotating cage decreases the exit velocity of the nuts out of the discharge portion 400, thereby minimizing damage to the nuts as they discharge. In another embodiment without departing from this invention, the extended tabs 334 on the rotor paddles 332 may be replaced with a rotating sheave bolted to the rear face of the rotor paddles 332. The rotating sheave directs the flow of the nuts towards the exit port of the discharge portion 400. Additionally, the rotating sheave decreases the exit velocity of the nuts out of the discharge portion 400, thereby minimizing damage to the nuts as they discharge.

Additionally, the second rotary module 300 may include a rotating back ring coupled to the rotor 330. The back ring may be utilized instead of the rotor paddles to provide positive discharge without creating a pinch point (similar to the action created from a vortex pump).

In another embodiment, the rotor paddles 332 may have a paddle profile designed to lift the nut and separate the nut from any remaining cashew apple or fiber material. The paddle profile may have a sharp “undercut” to more aggressively engage the fiber and push the fiber into the screen 310 and/or shear it off

Additionally, a hook may be utilized to help clear out the rotor of cashew apples and nuts. The rotor hook may be a long stainless steel rod. The rotor hook may include a 180 degree curved end. The rotor hook may allow the clearing out of the spaces between the rotor paddles 332. The rotor hook may be designed to clear out the spaces between the rotor paddles 332 and the vanes 234 for the full length of the machine back to the entrance into the first rotary module 200.

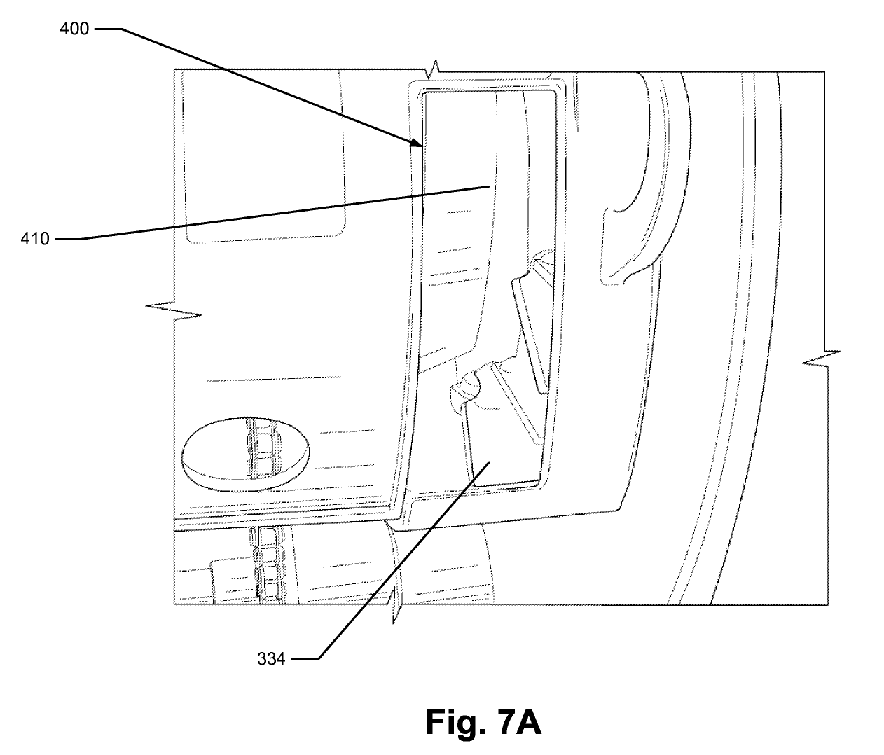

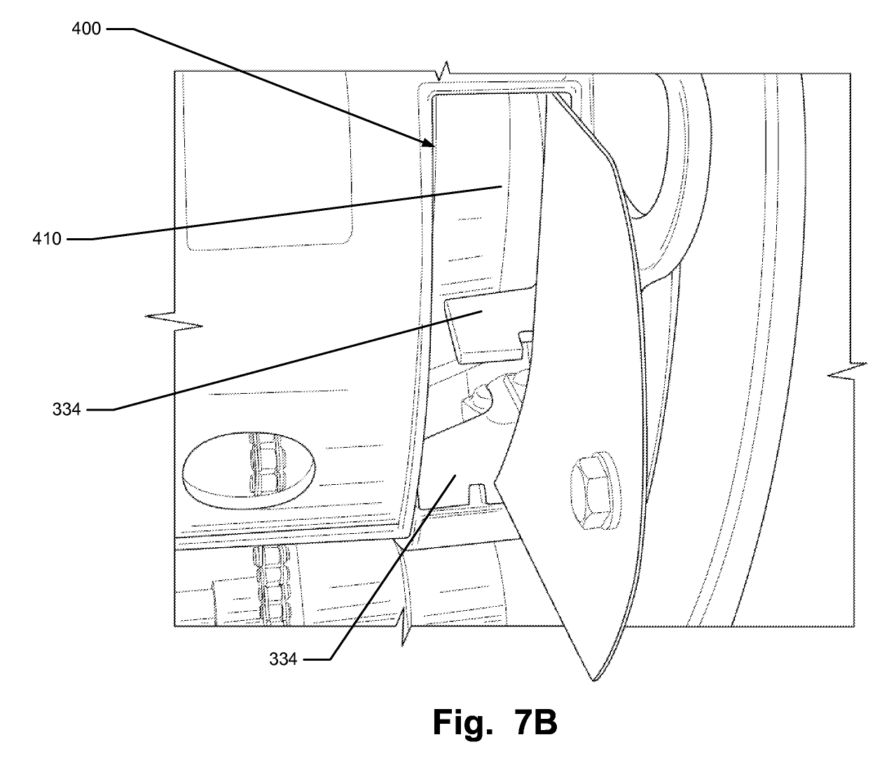

As illustrated in FIGS. 7A and 7B, the discharge portion 400 is located at the end of the second rotary module 300. The second rotary module 300 passes the nuts through the rotor with minimal damage to the discharge portion 400. The discharge portion 400 includes a discharge port 410. The discharge port 410 may be generally rectangular in shape, although other shapes may be utilized without departing from this invention. The discharge port 410 may be designed to minimize all nut impact points as those impact points result in damage to the nuts.

As illustrated in FIG. 7B, the discharge port 410 may include a barrier or fence. The barrier may be installed to keep the nuts from hitting the edge of the discharge port 410, which will greatly reduce the damage to the nuts. The barrier may be a ridge barrier mounted to the outside of the port but protruding inside the discharge port 410. In one embodiment, the barrier may protrude inside the discharge port 410 approximately ⅜ inches. In other embodiments, the barrier may protrude inside the discharge port 410 different dimensions, such as ½ inch, ¼ inch, and ¾ inches. Other dimensions may be utilized without departing from this invention. The barrier acts to ensure that the nuts do not exit the discharge port 410 along the leading or side edge. As shown in FIG. 7B, it may be necessary to cut a matching notch or slit in the rotor paddles 332, such as if the paddles 332 are configured with tabs 334. The notch may create a passageway for the barrier with the rotor paddles as the rotor turns.

The discharge port 410 may also open up a discharge size for a full 180 degrees. This might require removing all the paddle ends to the rotor paddles 332. This might also require additional stiffening of the bearing section that is designed to minimize impact damage to the nuts and retention of fibrous materials. Additionally, the discharge port with a 180 degree opening may include a sliding door. The sliding door would allow and permit the regulation of the size of the opening.

Additionally, in another embodiment, the trailing edges of the rotor paddles 332 may be trimmed by a certain amount. In one embodiment, the rotor paddles 332 may be trimmed by ½ inches. In another embodiment, the rotor paddles 332 may be trimmed by 1 inch. In the embodiment illustrated in FIGS. 5 and 7A, the trailing edges of the rotor paddles 332 do not overlap the discharge port 410. In this configuration, the trailing edges of the rotor paddles 332 cannot trap the nuts against the edges of the discharge port 410 and potentially shear the nuts as the nuts are exiting the port 410. Further, the exit momentum of the nuts may be slowed in this configuration, thus creating a lower damage scenario. The use of the barrier may not be necessary if the paddle configuration in FIGS. 5 and 7A is utilized.

In another embodiment, the discharge port 410 may include a discharge bevel attached to the discharge port 410. The discharge bevel may be directed toward the screen to effectively increase the width of the discharge port 410.

Additionally, the discharge port may include a split discharge port. The split discharge port would allow the flow of the nuts to be separated. For example, visual standards may be established for nuts, classifying them as “Good,” “Damaged (but sellable),” and “Broken (not sellable).” Electronic vision machines may also be utilized for the classification of nuts.

In another embodiment, the discharge portion 410 may include fitments at the exterior of the discharge port 410 to facilitate nut sample collection. Also, either in addition to or in place of, the fitments at the exterior of the discharge port 410 may facilitate the transition to a product (nut) takeaway system that is either a water flume, auger in a trough, or a mechanical conveyor. An impact-reducing mechanism may be used at the discharge port 410 as well, such as container or takeaway system with installed cushioning or a container filled with water or another fluid to absorb the impact of the nuts and reduce damage. Other product takeaway systems may be utilized with this system as required. In another embodiment, a screening device may be utilized as part of the takeaway system to separate out loose fiber tails from the products (nuts). The separated tails may also be captured as by-product for future use. In a further embodiment, a vacuum or similar mechanism may be used at or downstream of the discharge port 410 to pull loose fiber away from the nuts.

While specific embodiments and examples have been described and illustrated herein, it is understood that further embodiments and variations may exist within the scope and spirit of the invention, and that the scope of the invention is limited only by the claims.

What is claimed is:

1. A system configured for processing plant tissue to separate a hard component from soft matter connected to the hard component, the system comprising:
a first rotary module comprising a cylindrical first chamber defined by an inner surface and a first rotary assembly disposed within the first chamber, the inner surface having a plurality of projections and a plurality of troughs interspersed between the projections, wherein the first rotary assembly comprises a first shaft that is powered for rotation within the first chamber and a plurality of first vanes extending radially from the first shaft and extending longitudinally along at least a portion of a length of the first shaft, each of the first vanes having a free edge adjacent the inner surface, and each of the first vanes having a knife connected to the free edge, wherein the first rotary module is configured for crushing the soft matter by contact of the soft matter with the first vanes and the inner surface during rotation of the first rotary assembly to form a pulp, and wherein the knives are configured for cutting the hard component from a fibrous component of the pulp; and
a second rotary module in communication with the first chamber of the first rotary module such that the first rotary module is configured to feed the hard component and the pulp into the second rotary module, the second rotary module comprising a cylindrical screen defining a cylindrical second chamber and a second rotary assembly disposed within the second chamber, the screen having a plurality of passages, wherein the second rotary assembly comprises a second shaft that is powered for rotation within the second chamber and a plurality of paddles extending radially from the second shaft and extending longitudinally along at least a portion of a length of the second shaft, wherein the second rotary module is configured for separating the hard component from the pulp by rotation of the second rotary assembly, such that the passages are configured to permit the pulp to pass through and prevent passage of the hard component.

2. The system of claim 1, further comprising:
an infeed assembly configured for feeding the hard component and the connected soft matter into the first rotary module.

3. The system of claim 1, further comprising:
a discharge portion in communication with the second chamber of the second rotary module, wherein the discharge portion is configured to discharge the hard component through an exit port after separation by the second rotary module.

4. The system of claim 1, wherein each of the first vanes has a rear end proximate an output of the first rotary module and a fin projecting from the rear end, wherein each of the fins has a leading edge projecting longitudinally and radially outward from the free edge of the first vane to which the respective fin is connected.

5. The system of claim 4, wherein each of the fins has a second knife located thereon, the second knife located on the leading edge of the respective fin.

6. The system of claim 5, wherein each of the second knives is integrally formed on the leading edge of the fin.

7. The system of claim 5, wherein each of the second knives is removably connected to a side of the respective fin and extends parallel and adjacent to the leading edge.

8. The system of claim 1, wherein each of the knives is removably connected to a side of the respective first vane and extends parallel and adjacent to the free edge of the first vane.

9. The system of claim 1, wherein a maximum clearance between the free edges of the first vanes and the inner surface of the first chamber is no greater than ⅛ inch.

10. The system of claim 1, wherein a maximum clearance between the knives and the inner surface of the first chamber is no greater than ⅛ inch.

11. The system of claim 1, wherein each of the first vanes has a leading edge distal from the second rotary module, wherein each leading edge is beveled to form an angle of greater than 90° between the free edge and the leading edge.

12. The system of claim 1, wherein the first rotary assembly and the second rotary assembly rotate at approximately 600 to 1200 RPM.

13. The system of claim 1, wherein the first rotary assembly has a leading face with a conical surface, the conical surface being angled at an angle of approximately 15° to 75° with respect to a rotational axis of the first rotary assembly as defined by the first shaft.

14. A system configured for processing plant tissue to separate a hard component from soft matter connected to the hard component, the system comprising:
a first rotary module comprising a cylindrical first chamber defined by an inner surface and a first rotary assembly disposed within the first chamber, the inner surface having a plurality of projections and a plurality of troughs interspersed between the projections, wherein the first rotary assembly comprises a first shaft that is powered for rotation within the first chamber and a plurality of first vanes extending radially from the first shaft and extending longitudinally along at least a portion of a length of the first shaft, each of the first vanes having a front end, a rear end proximate an output of the first rotary module, and a free edge adjacent the inner surface, wherein the first rotary module is configured for crushing the soft matter by contact of the soft matter with the first vanes and the inner surface during rotation of the first rotary assembly to form a pulp; and
a second rotary module comprising a cylindrical screen defining a cylindrical second chamber and a second rotary assembly disposed within the second chamber, the second chamber having an entry end in communication with the output of the first chamber of the first rotary module, such that the first rotary module is configured to feed the hard component and the pulp into the entry end of the second chamber, and an exit end opposite the entry end, the screen having a plurality of passages, wherein the second rotary assembly comprises a second shaft that is powered for rotation within the second chamber and a plurality of paddles extending radially from the second shaft and extending longitudinally along at least a portion of a length of the second shaft, wherein the second rotary module is configured for separating the hard component from the pulp by rotation of the second rotary assembly, such that the passages are configured to permit the pulp to pass through and prevent passage of the hard component, wherein each of the paddles is generally aligned with one of the vanes of the first rotary module and each of the paddles has a leading edge proximate the entry end that is spaced 1/16″ or less from the rear end of the vane with which the respective paddle is generally aligned.

15. The system of claim 14, wherein each of the first vanes has a fin projecting from the rear end, wherein each of the fins projects longitudinally and radially outward from the free edge of the first vane to which the respective fin is connected, and wherein the leading edge of each vane is spaced 1/16″ or less from the fin of the vane with which the respective paddle is generally aligned.

16. The system of claim 14, further comprising:
an infeed assembly configured for feeding the hard component and the connected soft matter into the first rotary module.

17. The system of claim 14, further comprising:
a discharge portion in communication with the second chamber of the second rotary module, wherein the discharge portion is configured to discharge the hard component through an exit port after separation by the second rotary module.

18. The system of claim 14, wherein the passages of the screen have a maximum dimension that is no greater than 50% of the smallest diameter of the hard component being processed.

19. The system of claim 14, wherein the first chamber and the second chamber are continuous with each other and form a single, continuous chamber.

20. The system of claim 14, wherein the first rotary assembly and the second rotary assembly rotate at approximately equal speeds.

21. The system of claim 20, wherein the first shaft and the second shaft are operably locked, such that the first and second shafts rotate together.

22. The system of claim 14, wherein the first rotary assembly and the second rotary assembly rotate at approximately 600 to 1200 RPM.

23. The system of claim 14, wherein the first rotary assembly has a leading face with a conical surface, the conical surface being angled at an angle of approximately 15° to 75° with respect to a rotational axis of the first rotary assembly as defined by the first shaft.

24. A system configured for processing plant tissue to separate a hard component from soft matter connected to the hard component, the system comprising:
a first rotary module comprising a cylindrical first chamber defined by an inner surface and a first rotary assembly disposed within the first chamber, the inner surface having a plurality of projections and a plurality of troughs interspersed between the projections, wherein the first rotary assembly comprises a first shaft that is powered for rotation within the first chamber and a plurality of first vanes extending radially from the first shaft and extending longitudinally along at least a portion of a length of the first shaft, each of the first vanes having a free edge adjacent the inner surface, wherein the first rotary module is configured for crushing the soft matter by contact of the soft matter with the first vanes and the inner surface during rotation of the first rotary assembly to form a pulp;
a second rotary module comprising a cylindrical screen defining a cylindrical second chamber and a second rotary assembly disposed within the second chamber, the second chamber having an entry end in communication with the first chamber of the first rotary module, such that first rotary module is configured to feed the hard component and the pulp into the entry end of the second chamber, and an exit end opposite the entry end, the screen having a plurality of passages, wherein the second rotary assembly comprises a second shaft that is powered for rotation within the second chamber and a plurality of paddles extending radially from the second shaft and extending longitudinally along at least a portion of a length of the second shaft, wherein the second rotary module is configured for separating the hard component from the pulp by rotation of the second rotary assembly, such that the passages are configured to permit the pulp to pass through and prevent passage of the hard component; and
a discharge portion in communication with the exit end of the second chamber of the second rotary module, wherein the discharge portion is configured to discharge the hard component through an exit port after separation by the second rotary module, the exit port being positioned adjacent to the exit end of the second chamber,
wherein each of the paddles has a rear end at the exit end of the second chamber, and wherein the rear ends of the paddles do not overlap the exit port.

25. The system of claim 24, wherein the discharge portion comprises an extension of the second chamber, the extension defined by a cylindrical wall, and the exit port comprises a circumferential opening in the cylindrical wall.

26. The system of claim 24, further comprising:
an infeed assembly configured for feeding the hard component and the connected soft matter into the first rotary module.

27. The system of claim 24, wherein the passages of the screen have a maximum dimension that is no greater than 50% of the smallest diameter of the hard component.

28. The system of claim 24, wherein the first chamber and the second chamber are continuous with each other and form a single, continuous chamber.

29. The system of claim 24, wherein the second rotary assembly rotates at approximately 600 to 1200 RPM.

30. The system of claim 29, wherein the first rotary assembly and the second rotary assembly rotate at approximately equal rotational speeds.

31. The system of claim 24, wherein the first rotary assembly has a leading face with a conical surface, the conical surface being angled at an angle of approximately 15° to 75° with respect to a rotational axis of the first rotary assembly as defined by the first shaft.

32. A system configured for processing plant tissue to separate a hard component from soft matter connected to the hard component, the system comprising:
a first rotary module comprising a cylindrical first chamber defined by an inner surface and a first rotary assembly disposed within the first chamber, the inner surface having a plurality of projections and a plurality of troughs interspersed between the projections, wherein the first rotary assembly comprises a first shaft that is powered for rotation within the first chamber and a plurality of first vanes extending radially from the first shaft and extending longitudinally along at least a portion of a length of the first shaft, each of the first vanes having a free edge adjacent the inner surface, wherein the first rotary module is configured for crushing the soft matter by contact of the soft matter with the first vanes and the inner surface during rotation of the first rotary assembly to form a pulp; and
a second rotary module comprising a cylindrical screen defining a cylindrical second chamber and a second rotary assembly disposed within the second chamber, the second chamber having an entry end in communication with the first chamber of the first rotary module, such that the first rotary module is configured to feed the hard component and the pulp into the entry end of the second chamber, and an exit end opposite the entry end, the screen having a plurality of passages, wherein the second rotary assembly comprises a second shaft that is powered for rotation within the second chamber and a plurality of paddles extending radially from the second shaft and extending longitudinally along at least a portion of a length of the second shaft, wherein the second rotary module is configured for separating the hard component from the pulp by rotation of the second rotary assembly, such that the passages are configured to permit the pulp to pass through and prevent passage of the hard component; and
a discharge portion in communication with the exit end of the second chamber of the second rotary module, wherein the discharge portion is configured to discharge the hard component through an exit port after separation by the second rotary module, the exit port being positioned adjacent to the exit end of the second chamber, the discharge portion further comprising a barrier plate extending into the exit port along an edge of the exit port adjacent the second chamber to form a barrier between the edge of the exit port and the exit end of the second chamber.

33. The system of claim 32, wherein each of the paddles has a rear end at the exit end of the chamber, and wherein the rear ends of the paddles overlap the exit port, and each of the rear ends has a slit therein configured to provide clearance for the barrier plate to pass through the slit during rotation of the second rotary assembly.

34. The system of claim 32, wherein the barrier plate is connected to the discharge portion outside the exit port and extends into the exit port from outside the exit port.

35. The system of claim 32, further comprising:
an infeed assembly configured for feeding the hard component and the connected soft matter into the first rotary module.

36. The system of claim 32, wherein the passages of the screen have a maximum dimension that is no greater than 50% of the smallest diameter of the hard component.

37. The system of claim 32, wherein the first chamber and the second chamber are continuous with each other and form a single, continuous chamber.

38. The system of claim 32, wherein the second rotary assembly rotates at approximately 600 to 1200 RPM.

39. The system of claim 32, wherein the first rotary assembly and the second rotary assembly rotate at approximately equal rotational speeds.

40. The system of claim 32, wherein the discharge portion comprises an extension of the second chamber, the extension defined by a cylindrical wall, and the exit port comprises a circumferential opening in the cylindrical wall.

41. The system of claim 32, wherein the first rotary assembly has a leading face with a conical surface, the conical surface being angled at an angle of approximately 15° to 75° with respect to a rotational axis of the first rotary assembly as defined by the first shaft.

42. A system configured for processing plant tissue to separate a hard component from soft matter connected to the hard component, the system comprising:
an infeed assembly comprising an auger configured for moving the hard component with the connected soft matter;
a first rotary module comprising a cylindrical first chamber defined by an inner surface and a first rotary assembly disposed within the first chamber, the first chamber having an entry end adjacent an end of the auger, such that the auger is configured for feeding the hard component and the connected soft matter into the entry end, and an exit end opposite the entry end, the inner surface having a plurality of projections and a plurality of troughs interspersed between the projections, wherein the first rotary assembly comprises a first shaft that is powered for rotation within the first chamber and a plurality of first vanes extending radially from the first shaft and extending longitudinally along at least a portion of a length of the first shaft, each of the first vanes having a free edge adjacent the inner surface, and each of the first vanes having a knife connected to the free edge, wherein the first rotary module is configured for crushing the soft matter by contact of the soft matter with the first vanes and the inner surface during rotation of the first rotary assembly to form a pulp, and wherein the knives are configured for cutting the hard component from a fibrous component of the pulp;
a second rotary module comprising a cylindrical screen defining a cylindrical second chamber and a second rotary assembly disposed within the second chamber, the second chamber having an entry end in communication with the exit end of the first chamber of the first rotary module, such that the first rotary module is configured to feed the hard component and the pulp from the exit end of the first chamber into the entry end of the second chamber, and the second chamber further having an exit end opposite the entry end, the screen having a plurality of passages, wherein the second rotary assembly comprises a second shaft that is powered for rotation within the second chamber and a plurality of paddles extending radially from the second shaft and extending longitudinally along at least a portion of a length of the second shaft, wherein the second rotary module is configured for separating the hard component from the pulp by rotation of the second rotary assembly, such that the passages are configured to permit the pulp to pass through and prevent passage of the hard component; and
a discharge portion in communication with the exit end of the second chamber of the second rotary module, wherein the discharge portion is configured to discharge the hard component through an exit port after separation by the second rotary module, the exit port being positioned adjacent to the exit end of the second chamber, wherein the discharge portion comprises an extension of the second chamber, the extension defined by a cylindrical wall, and the exit port comprises a circumferential opening in the cylindrical wall.

43. The system of claim 42, wherein the discharge portion further comprises a barrier plate extending into the exit port along an edge of the exit port adjacent the second chamber to form a barrier between the edge of the exit port and the exit end of the second chamber, and wherein each of the paddles has a rear end at the exit end of the chamber, and wherein the rear ends of the paddles overlap the exit port, and each of the rear ends has a slit therein configured to provide clearance for the barrier plate to pass through the slit during rotation of the second rotary assembly.

44. The system of claim 42, wherein each of the paddles has a rear end at the exit end of the second chamber, and wherein the rear ends of the paddles do not overlap the exit port.

45. The system of claim 42, wherein the first rotary assembly has a leading face with a conical surface, the conical surface being angled at an angle of approximately 15° to 75° with respect to a rotational axis of the first rotary assembly as defined by the first shaft.
